(19) United States
(12) Patent Application Publication
(10) Pub. No.: US 2018/0204270 A1
(43) Pub. Date: Jul. 19, 2018

(54) Method, Apparatus, and System for Data Object Information Processing

(71) Applicant: Alibaba Group Holding Limited, Grand Cayman (KY)

(72) Inventors: Fei Cheng, Hangzhou (CN); Guangqian Dong, Hangzhou (CN)

(21) Appl. No.: 15/874,782

(22) Filed: Jan. 18, 2018

(30) Foreign Application Priority Data
Jan. 19, 2017 (CN) 201710039090.9

(51) Int. Cl. G06Q 30/06

(52) U.S. Cl. CPC G06Q 30/0633; G06Q 30/0246; G06Q 30/0641

(57) ABSTRACT

A system including a server of an information publishing subsystem to be accessed into an access subsystem. The access subsystem, according to the accessed information publishing system, provides an effective information publishing system list to a data object placement subsystem. The data object placement subsystem selects a target information publishing subsystem from the effective information publishing subsystem list for placement of data object information. A client terminal of the information publishing subsystem receives the data object list corresponding to the information publishing subsystem from the access subsystem, generates the virtual item according to the data object information, uses the virtual item to send information, and provides corresponding data object information when the data object corresponding to the virtual item is operated. The present disclosure enriches the placement channels of the data objects, and improves the click through rate and conversion rate of the data object.

### CROSS REFERENCE TO RELATED PATENT APPLICATIONS

This application claims priority to Chinese Patent Application No. 201710039090.9, filed on 19 Jan. 2017, entitled “Method, Apparatus, and System for Data Object Information Processing,” which is hereby incorporated by reference in its entirety.

### TECHNICAL FIELD

The present disclosure relates to the field of data object information processing technologies, and particularly to methods, apparatuses, and systems for data object information processing.

### BACKGROUND

An effective way to improve click through rate of a webpage is to place the webpage link through multiple channels. Similarly, in order to improve the visibility of their products, merchants or the seller users in the network transaction system may also select various types of channels outside the sales platform to place links of their products, in addition to placing links on the homepage of the sales platform or actively participating in certain activities organized by the platform. The merchants or the seller users expect to achieve a higher click-through rate, which in turn increases the sales of their products.

In conventional techniques, there are various types of information distribution channels such as the portal website, the video platform, or the search platform. However, locating more distribution channels has always been the goal pursued by marketing personnel. Correspondingly, how to provide technical support when discovering new distribution channels has also become a technical issue that needs to be solved by those skilled in the art.

### SUMMARY

This Summary is provided to introduce a selection of concepts in a simplified form that are further described below in the Detailed Description. This Summary is not intended to identify all key features or essential features of the claimed subject matter, nor is it intended to be used alone as an aid in determining the scope of the claimed subject matter. The term “technique(s) or technical solution(s)” for instance, may refer to apparatus(s), system(s), method(s) and/or computer-readable instructions as permitted by the context above and throughout the present disclosure. The present disclosure provides a method and device for multi-display interaction, which makes the interaction process more vivid and real, which improves the user engagement.

The present disclosure provides a data object information processing method, apparatus and system, which enrich the placement channel of the data object and improve the click rate and the conversion rate of the data object.

The present disclosure provides the following solutions:

A data object information processing system, the system includes a data object information subsystem and an information publishing subsystem, wherein:

The data object information subsystem provides selectable data object information to the information publishing subsystem.

The information publishing subsystem includes a server and a client terminal.

The server selects target data object information from the selectable data object information and provides virtual item information according to the target data object information when receiving a request for displaying a virtual item list sent from a client terminal, and returns the virtual item information to the client terminal.

The client terminal displays, in the virtual item list, the virtual item information generated according to the data object information.

A data object information processing system includes an access subsystem, at least one information publishing subsystem, and at least one data object placement subsystem. The information publishing subsystem includes a server and a client terminal.

The server of the information publishing subsystem accesses the access subsystem;

The access subsystem provides the data object placement subsystem with an effective information publishing subsystem list according to the accessed information publishing subsystem;

The data object placement subsystem selects a target information publishing subsystem from the effective information publishing subsystem list to place data object information, and the access subsystem stores the corresponding relationship between the information publishing subsystem and the data object information.

The client terminal of the information publishing subsystem obtains a data object list corresponding to the information publishing subsystem from the access subsystem, generates a virtual item according to the data object information, sends the information by using the virtual item, and, when the data object corresponding to the virtual item is operated, provides the corresponding data object information.

A data object information processing method includes:

A first user client terminal of the information publishing subsystem provides selectable virtual item information at a first user interface, where the first user interface further includes information published by a second user client terminal of the information publishing subsystem and a virtual item is generated according to the data object information.

After the target virtual item is selected, a resource sending request is submitted to the server of the information publishing subsystem, and the server adds the target virtual item to the received virtual item list associated with the second user client terminal.

A method for providing data object information includes:

A second user client terminal of the information publishing subsystem provides a second user interface which includes the information published by the second user client terminal and the received virtual item list associated with the second user client terminal, wherein the received virtual item list includes a target virtual item generated according to a preset data object;

When an operation request for the target virtual item is received, the information of the data object corresponding to the target virtual item is provided.

A method for providing data object information includes:

A third user client terminal of the information publishing subsystem provides a third user interface. The third user interface includes information published by a second user client terminal and a received virtual item list that is associated with the second user client terminal. The received virtual item list includes a target virtual item generated according to a preset data object.

When an operation request for the target virtual item is received, the information of the data object corresponding to the target virtual item is provided.

A method for providing data object information includes:

The server of the information publishing subsystem selects the target data object from the data object list provided by the data object information subsystem.

The virtual item information is generated according to the target data object.

When a request for obtaining virtual item information submitted by a first user client terminal is received, the virtual item information is provided, and the first user client terminal provides the virtual item information at a user interface.

A method for providing data object information includes:

The access subsystem generates a selectable information publishing subsystem list according to the access request of the information publishing subsystem.

When a data object placement request is received, the information publishing subsystem list is provided;

The data object to be placed by the target information publishing subsystem is stored. When the first user client terminal of the information publishing subsystem provides the request for obtaining the data object information, the data object corresponding to the target information publishing subsystem is returned to the first user client terminal. The first user terminal generates the virtual item according to the data object information.

A method for providing data object information includes:

The server of the information publishing subsystem sends an access request to the access subsystem so that the access subsystem adds the information publishing subsystem to the selectable information publishing subsystem list and, when receiving the data object placement request, provides the information publishing subsystem list, and perform the data object placement to the information publishing subsystem.

After the access is successful, the software development kit (SDK) returned by the access subsystem is received, and the SDK package is provided to the client terminal of the information publishing subsystem. The client terminal of the information publishing subsystem installs the SDK package, establishes an information interaction channel with the access subsystem, obtain a data object list corresponding to the information publishing subsystem from the access subsystem, and generates a virtual item according to the data object information.

A method for providing data object information includes:

The data object placement subsystem obtains the information publishing subsystem list through the access subsystem.

A target information publishing subsystem is selected from the information publishing subsystem list to perform data object information placement, and the access subsystem stores the corresponding relationship between the information publishing subsystem and the data object information, so that the first user client terminal of the information publishing subsystem generates the virtual item information according to the corresponding data object information.

An apparatus for processing data object information applied to a first user client terminal of an information publishing subsystem, includes:

a virtual item information providing unit that provides selectable virtual item information at a first user interface, wherein the first user interface further includes information published by a second user client terminal of the information publishing subsystem, and the virtual item is generated based on the data object information; and

a resource sending request submitting unit that submits a resource sending request to a server of the information publishing subsystem after the target virtual item is selected and the server adds the target virtual item to the received virtual item list associated with the second user client terminal.

An apparatus for providing data object information, which is applied to a second user client terminal of an information publishing subsystem, includes:

an interface providing unit that provides a second user interface, where the second user interface includes information published by the second user client terminal and a received virtual item list that is associated with the second user client terminal, and the received virtual item list includes a target virtual item generated according to a preset data object; and

a data object information providing unit that provides information of a data object corresponding to the target virtual item when receiving an operation request for the target virtual item.

An apparatus for providing data object information, which is applied to a third user client terminal of an information publishing subsystem, includes:

an interface providing unit that provides a third user interface, where the third user interface includes information published by a second user client terminal and a received virtual item list that is associated with the second user client terminal, and the received virtual item list includes the target virtual item generated according to the preset data object; and

a data object information providing unit that provides information of a data object corresponding to the target virtual item when receiving an operation request for the target virtual item.

An apparatus for providing data object information, which is applied to a server of an information publishing subsystem, includes:

a data object selection unit that selects a target data object from a data object list provided by a data object information subsystem;

a virtual item generating unit that generates virtual item information according to the target data object;

a virtual item providing unit that provides the virtual item information when receiving a request for obtaining virtual item information submitted by a first user client terminal so that the first user client terminal provides the virtual item information at the user interface.

An apparatus for providing data object information, applied to an access subsystem, includes:

a list generating unit that generates a selectable information publishing subsystem list according to the access request of the information publishing sub-system;

a list providing unit that provides the information publishing subsystem list when receiving the data object placing request; and

a data object information storing unit that determines and store the data object information to be placed by the target information publishing subsystem and returns the data object information corresponding to the information publishing subsystem to the first user client terminal when receiving the request for obtaining the data object information submitted by the first user client terminal of the information publishing subsystem so that the first user client terminal generates a virtual item according to the data object information.

An apparatus for providing data object information, which is applied to a server of an information publishing subsystem, includes:

an access request sending unit that sends an access request to an access subsystem, so that the access subsystem adds the information publishing subsystem to a selectable information publishing subsystem list and, when receiving a data object placement request, provides the information publishing subsystem list and performs the data object placement to the information publishing subsystem; and

an installation package receiving unit that receives a SDK returned by the access subsystem after the access is successful and provides the SDK package to a client terminal of an information publishing subsystem so that the client terminal of the information publishing subsystem establishes an information exchange channel with the access subsystem by installing the SDK package and obtains a data object list corresponding to the information publishing subsystem from the access subsystem and generates a virtual item according to the data object information.

An apparatus for providing data object information, applied to a data object placement subsystem, includes:

a list obtaining unit that obtains an information publishing subsystem list through an access subsystem; and

a data object information placement unit that selects a target information publishing subsystem from the information publishing subsystem list to perform data object information placement, and the access subsystem stores the corresponding relationship between the information publishing subsystem and the data object information so that the first user client terminal of the information publishing subsystem generates the virtual item information according to the corresponding data object information.

According to the example embodiments provided by the present disclosure, the present disclosure discloses the following technical effects:

By using the example embodiments of the present disclosure, the virtual item display and sending functions in the information publishing subsystem are used as the placement channels of the data objects. In this way, the virtual items in the information publishing subsystem are displayed in more abundant forms and at the same time the placement channels of the data objects are enriched. As the process of sending the virtual item is an intentional act of the user, compared with the compulsory advertisement placement or in-stream, the user acceptance degree is high. Thus, the user experiences are improved while the data object click rate and conversion rate are increased.

Certainly, implementing any of the products of the present disclosure does not necessarily require achieving all of the advantages described above at the same time.

### BRIEF DESCRIPTION OF THE. DRAWINGS

To describe the technical solutions in the example embodiments of the present disclosure more clearly, the following briefly introduces the accompanying drawings for describing the example embodiments. Apparently, the drawings in the following description represent only some of embodiments of the present disclosure. Those of ordinary skill in the art, without creative efforts, may derive other drawings from these drawings.

FIG. 1 is a diagram of a first system according to an example embodiment of the present disclosure;

FIG. 2 is a diagram of a second system according to an example embodiment of the present disclosure;

FIG. 3 is a flow chart of a first method according to an example embodiment of the present disclosure;

FIG. 4(A) to 4(E) are diagrams of a user interface according to an example embodiment of the present disclosure;

FIG. 5 is a flowchart of a second method according to an example embodiment of the present disclosure;

FIG. 6 is a flowchart of a third method according to an example embodiment of the present disclosure;

FIG. 7 is a flow chart of a fourth method according to an example embodiment of the present disclosure;

FIG. 8 is a flow chart of a fifth method according to an example embodiment of the present disclosure;

FIG. 9 is a flow chart of a sixth method according to an example embodiment of the present disclosure;

FIG. 10 is a flowchart of a seventh method according to an example embodiment of the present disclosure;

FIG. 11 is a schematic diagram of a first apparatus according to an example embodiment of the present disclosure;

FIG. 12 is a schematic diagram of a second apparatus according to an example embodiment of the present disclosure;

FIG. 13 is a schematic diagram of a third apparatus according to an example embodiment of the present disclosure;

FIG. 14 is a schematic diagram of a fourth apparatus according to an embodiment of the present disclosure; and

FIG. 15 is a schematic diagram of a fifth apparatus according to an embodiment of the present disclosure.

FIG. 16 is a schematic diagram of a sixth apparatus according to an embodiment of the present disclosure.

FIG. 17 is a schematic diagram of a seventh apparatus according to an embodiment of the present disclosure.

### DETAILED DESCRIPTION

The technical solutions in the example embodiments of the present disclosure are clearly and completely described below with reference to the accompanying drawings. Apparently, the described example embodiments merely represent some and not all of the embodiments of the present disclosure. All other embodiments obtained by those of ordinary skill in the art based on the example embodiments of the present disclosure shall fall within the protection scope of the present disclosure.

During the implementation of the present disclosure, the inventors of the present disclosure found that, in some information publishing subsystems, users may publish their own original contents, such as videos, audios, articles, pictures. Such contents may be edited in advance and then posted on a platform, such as posting a captured photo to the platform, or recorded video audio (e.g., a song sung by the publisher, etc.) In addition, some information publishing subsystems may also support real-time publishing for video or audio content. For example, in some video broadcast platforms, publishers may play the role of “network anchor” to interact with other users in the platform in real time. At this point, the information published in the platform is the real-time video or audio information posted by this “anchor” user within the platform. In short, no matter what specific form of information release, other users within the platform can “watch” or interact with the publisher. If the user feels the content is good, interesting, the user may express appreciation to or encourage the publishers through the form of “reward.” In the conventional techniques, in order to realize the above “reward”, some selectable virtual items in the client terminal. For example, there are virtual flowers, virtual cars, etc. The user may select one of the virtual items to send to the information publisher. Each virtual item is associated with a certain amount of virtual resource information. The specific virtual item may be a virtual currency, an experience value, and the like. The user may obtain virtual resources by participating in a comment, publishing information, checking in or purchasing, and the like, After the virtual item is sent out, the virtual item information corresponding to the virtual item is transferred to the information publisher's account or shared between the publisher user and the information publishing subsystem, and so on. In the meantime, other onlookers may also see in the information interface which virtual items the information publisher has harvested, and so on.

In the above application scenario in the conventional techniques, the virtual item is used only as a carrier for the virtual resources. In the list of virtual items that the information publisher has received, only the pictures of the different virtual items are displayed. The onlooks may roughly judge the level of the virtual resource corresponding to the gift received by the information publisher through the value of the article in the virtual picture in real life. Therefore, the specific form of virtual items need to be enriched. In combination with the inventive objective of the present disclosure, the example embodiment of the present disclosure may use such a virtual item scene as a placement channel for data object information, so that the placed data object information may be a sent virtual item. After the information publisher obtains the virtual resources corresponding to the virtual item, other viewers may also view the information of the data objects from the list of virtual items that a user has received, and further perform operations such as clicking, viewing details and even purchasing. The following describes an implementations in detail.

A first example embodiment:

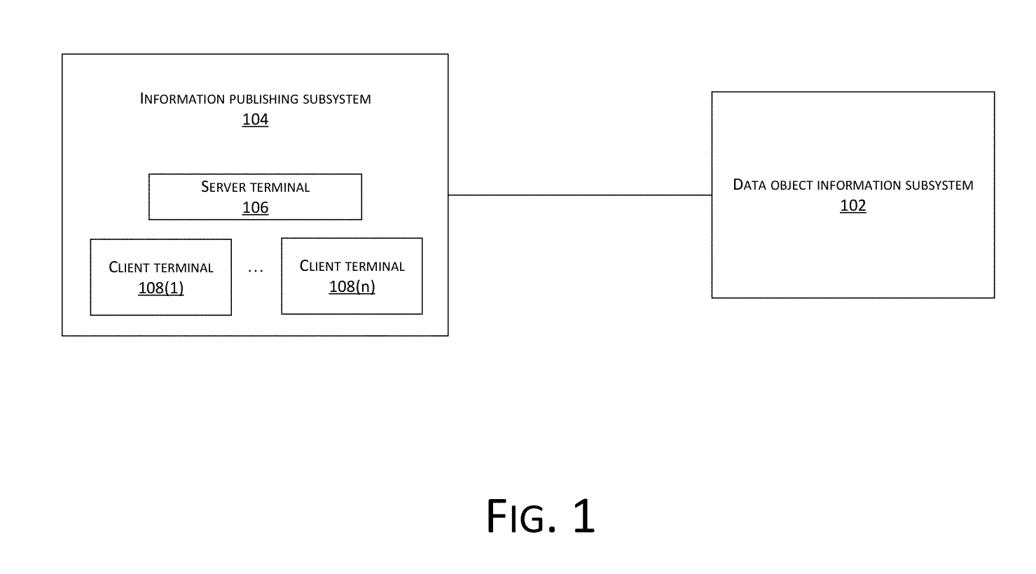

To achieve the above objective, in the first example embodiment of the present disclosure, firstly, a data object information processing system is provided from a system architecture perspective. Referring to FIG. 1, the system may include a data object information subsystem 102 and an information publishing subsystem 104, of which:

The data object information subsystem 102 provides selectable data object information to the information publishing subsystem.

The information publishing subsystem 104 may include a server 106 and one or more client terminals 108(1), . . . 108(n), where n may be any integer.

The server selects target data object information from the selectable data object information, provides virtual item information according to the target data object information when receiving a request for displaying a virtual item list sent from a client terminal, and returns the virtual item information to the client terminal.

The client terminal displays, in the virtual item list, the virtual item information generated according to the data object information.

That is, in this first example embodiment, the information publishing subsystem may have an association relationship with the data object information subsystem, such as a cooperation relationship, and the like so that the information publishing subsystem may access specific data stored in the data object information subsystem. The data object information subsystem may provide selectable data object information to the information publishing subsystem. Specifically, when the virtual item information needs to be configured, the server of the information publishing subsystem may select from the target data object information from the selectable data object information. In this way, upon receiving a request sent by a client terminal for displaying a virtual item list, the virtual item information is provided according to the target data object information and returned to the client terminal. The client terminal may display, in the virtual item list, the virtual item information generated according to the data object information.

In an implementation, the data object may include the product object published in an network transaction system. In this way, in this way, not only the representation forms of the virtual item information in the information publishing subsystem are richer, but also the product object information in the network transaction system has more exposure opportunities.

When saving the data object information, the data object information subsystem may provide special processing to the requirement for generating the virtual item in advance. For example, for each data object, the corresponding representative image information may be provided. In this way, the information publishing subsystem may obtain the representative image information of the specific data object and generate the specific virtual items accordingly. That is, the virtual item information generated by the server may include a virtual item image generated according to the representative image of the product object; in this case, the client terminal displays the virtual item image in the virtual item list.

In addition, the information provided by the data object information subsystem may further include the target page access address information corresponding to the data object. In this case, when generating the virtual item, the server may also include a link generated according to the target page access address corresponding to the product object. For the client terminal, when the virtual item in the virtual item list is operated, the target page may also be displayed according to the link.

In the first example embodiment, when the virtual item is provided in the information publishing subsystem, the virtual item is generated according to the specific data object information. In this way, the representations form of the virtual item information in the information publishing subsystem are richer, and the specific data object information have more exposure opportunities.

A second example embodiment:

In the first example embodiment, the information publishing subsystem and the data object information subsystem may be in a one-to-one bound relationship, and information may be exchanged between the two. In the second example embodiment, considering that in actual applications, the information publishing subsystem and the data object information subsystem are more mutually independent, and there are many information publishing subsystems, and data object information subsystems. In order to achieve the versatility of the techniques, make the information publishing subsystem and the data object information subsystem achieve many-to-many relationship to better achieve the multi-channel data object information placement, and let information publishing subsystem obtain more and more rich data object information to generate the virtual items, in the second embodiment of the present disclosure, an open service platform may also be provided, which acts as a bridge between the information publishing subsystem and the data object information subsystem.

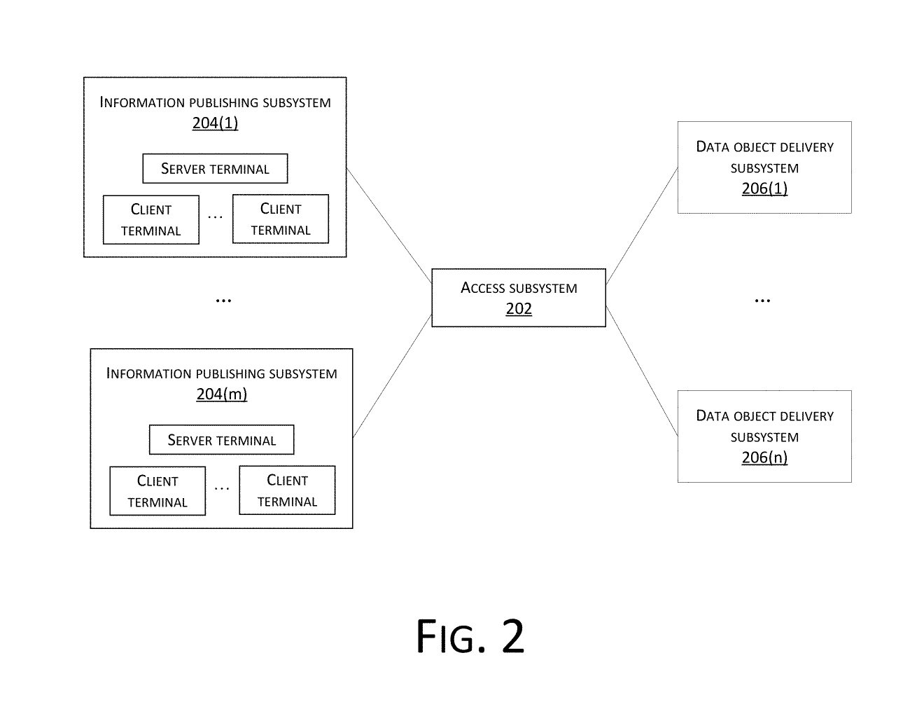

Specifically, referring to FIG. 2, in this second example embodiment, another data object information processing system is provided, and the system may include an access subsystem 202 (for example, the open service platform system and the like), at least one information publishing subsystem 204(1), . . . , 204(m), and at least one data object placement subsystem 206(1), . . . , 206(n), wherein m and n may be any integer and a respective information publishing subsystem 204 includes a server and a client terminal.

The server of the information publishing subsystem 204 accesses the access subsystem;

The access subsystem 202 provides the data object placement subsystem with an effective information publishing subsystem list according to the accessed information publishing subsystem.

The data object placement subsystem 206 selects a target information publishing subsystem from the effective information publishing subsystem list to perform data object information placement, and the access subsystem stores the corresponding relationship between the information publishing subsystem and the data object information;

The client terminal of the information publishing subsystem 204 obtains a data object list corresponding to the information publishing subsystem from the access subsystem, generates a virtual item according to the data object information, sends information by using the virtual item, and, when the data object corresponding to the virtual item is operated, provides corresponding data object information.

Specifically, the access subsystem 202 may provide an access portal for the information publishing subsystem 204 (such as a broadcast platform system). If the information publishing subsystem wants to cooperate with the access subsystem, provide information related to the data object (such as product objects, etc.), the information publishing subsystem may access the access subsystem. In addition, the access subsystem may also provide a SDK. The information publishing subsystem may download the SDK from the access subsystem and install it in its own client terminal so that the client terminal has communication, page jumps and other related functions with the access subsystem. It should be noted that the client terminal described in the example embodiments of the present disclosure may be a broad concept, and may include an SDK, such as an iOS SDK and Android SDK that is installed in an application such as a mobile application or, an SDK of a webpage, JavaScript SDK, etc.

After the information publishing subsystem completes the above access and SDK installation, the access subsystem adds the information publishing subsystem to a list of effective placement channels. In this way, the information publishing subsystem is found in the placement channel list when the data object is to be placed, and the information publishing subsystem is selected to place the data object. Certainly, in practical applications, the information publishing subsystem may also directly implement the functions related to communication and page jump with the access subsystem in the client terminal. In this case, there is no need to install the SDK package provided by the access subsystem.

The initiator of data object placement may be a third party to cooperate, such as “Ali mother” and other dedicated data object placement subsystem. In this case, in an implementation, the data object placement subsystem may also access the access subsystem in the example embodiment of the present disclosure, and may view the effective information publishing subsystem list in the access subsystem.

That is, in this example embodiment of the present disclosure, cooperation may be performed among the access subsystem, the information publishing subsystem and the data object placement subsystem, wherein both the information publishing subsystem and the data object placement subsystem may be connected into the open platform. The information publishing subsystem includes a server and a client terminal, wherein the client terminal of the sender of the virtual item is called a first user client terminal, the client terminal of the virtual item receiver is called a second user client terminal, and the client terminals of other audiences become the third user client terminal. In this way, an implementation process may be:

1. The server of the information publishing subsystem accesses the access subsystem through the access port provided by the access subsystem;

2. The information publishing subsystem downloads the SDK package from the access subsystem;

3. The information publishing subsystem installs the SDK package in each client terminal;

4. The access subsystem provides the data object placement subsystem with a list of effective information publishing subsystems;

5. The data object placement subsystem selects the information publishing subsystem from the list to publish the data object, and the access subsystem stores the corresponding relationship between the information publishing subsystem and the data object list.

6. When receiving the request for sending the virtual item, the first user client terminal may first obtain the data object list corresponding to the information publishing subsystem from the access subsystem;

7. The first user client terminal generates a virtual item according to the information in the received data object list.

8. When the target virtual item is selected, the target virtual item is sent to the second user client terminal, that is, the client terminal that is currently viewing the publisher of the information.

9. The information publishing subsystem may provide the received virtual item list associated with the second user to other “viewers” of the information published by the second user, i.e., the third user client terminal;

10. The first user client terminal, the second user client terminal, or the third user client terminal may all receive the user's operation on the data object corresponding to the virtual item and perform page jump. If the current user apparatus has already installed the network transaction system (for example, Taobao, Tmall, etc.) corresponding to the data object, the client terminal of the network transaction system is prompted to display the data object information.

Because different information publishing subsystems may have different data objects for placement, the access subsystem may save the corresponding relationship between the respective information publishing subsystems and the data objects to be placed. For example, a specific storing method is as shown in Table 1:

TABLE 1

| | Name of | |
|---|---|---|
| ID of Information | Information | |
| Publishing | Publishing | |
| Subsystem | Subsystem | Data Object List |
| 100001 | Platform A | Data object a1, Data object a2, . . . |
| 100002 | Platform B | Data object b1, Data object b2, . . . |
| . . . | . . . | . . . |

The specific data object may be a published data object in a preset network transaction system (for example, “Taobao”, “Tmall”, etc.), and the so-called data object may include a product object, a shop object, and the like. That is, in this example embodiment of the present disclosure, virtual items in an information publishing subsystem may be generated according to data objects published in a network transaction system and be associated with specific virtual resources, so that the virtual items may be used as a “gift” sent to the information publisher. Other viewers may also conduct operations, such as viewing, to the corresponding data objects in the list of virtual items obtained by the information publisher. It should be noted that when the data object placement subsystem performs data object placement to the information publishing subsystem, some related information of the data object in the network transaction system may be provided to the access subsystem, which is also stored by the access subsystem. For example, such related information may include the name, resource information, representative image, details link, and so on of the data object.

In actual implementation, the number of data objects to be placed may be relatively large. In order to obtain a better placement effect (which may be indicated by data such as a user's click-through rate and a page conversion rate), the information publishing subsystem may also be selected. Specifically, the access subsystem may also provide the features of each information publishing subsystem when providing the list of effective information publishing subsystems. In this way, the data objects may be precisely placed according to the features of each information publishing subsystem. The features of the information publishing subsystem may mainly include the attributes of the published information, audience features of the user group, and the like. The attribute of the information may be expressed by the content attribute of the information, for example, an information publishing subsystem is used to publish song type information, and the like. For example, an information publishing subsystem is mainly for student groups, another information publishing subsystem is mainly for mom groups, and so on. According to different information attributes and the features of the audience of user groups, the targeted placement of the data objects are achieved. For example, with respect to the information publishing subsystem for student groups, the data objects to be placed include data objects related to the students, such as a learning machine, a book, and the like. With respect to the information publishing subsystem for mom groups, the data objects served may include maternal and child category data objects, and so on.

In the above method, when the information publishing subsystem list is provided, the features of the information publishing subsystems are provided. The data object placement subsystem, according to such features, determines which data objects to be placed to a respective information publishing subsystem will achieve a high click through rate or page conversion rate. Alternatively, in another implementation method, the access subsystem may also determine data object features (including category, brand, etc.) that match the network live broadcast system in advance according to information attributes published by the information publishing subsystem and/or audience user group features. In this way, when the information publishing subsystem list is provided, the matching data object features corresponding to the respective information publishing subsystems are also provided so that the data objects are placed to the corresponding information publishing subsystem according to the data object features.

It should be noted that information about the information attributes and audience features of the information publishing subsystem may be provided by the information publishing subsystem when accessing the access subsystem. Alternatively, the access subsystem collects the relevant historical data of the information publishing subsystem, conducts analysis, and determines the information attributes and audience features of the respective information publishing subsystems.

In conclusion, through the above method, when a user in the information publishing subsystem needs to send a gift to the information publisher, the user clicks on an operation option such as “virtual item” at the user interface. Correspondingly, the client terminal of the information publishing subsystem (which pre-installs the SDK package provided by the access subsystem, or implements the corresponding functions) requests the access subsystem to obtain a list of data objects that have been placed in the information publishing subsystem. The access subsystem queries Table 1 through the identification information of the information publishing subsystem (such as Id, name) carried in the request, and returns the corresponding data object to the client terminal. The client terminal generates the virtual item according to the list of data objects. Thus, the user may use this virtual item to send a “gift” to the information publisher. It should be noted that when the virtual item is generated according to the data object, two pieces of information may be mainly included. On the one hand, the front-end display information of the virtual item may be generated according to the representative image or the like related to the data object (such as one piece of image, a dynamic picture, a three-dimensional stereoscopic picture, etc.). Such information may be displayed in the virtual items list for selection by the sender user. On the other hand, virtual resource information related to the virtual items may also be determined. Here, the virtual resource may exist in the form of resource representation in the information publishing subsystem. For example, the information publishing subsystem represents resources as “gold coins.” A certain number of gold coins is associated with the generated virtual item, and so on. In other words, the virtual resource associated with the virtual item and the resource information of the data object corresponding to the virtual item in the network transaction system may be different, but may have a correlation relationship. In other words, when the virtual resource corresponding to the virtual item is determined, the factors such as price of the corresponding data object in the network transaction system is used as reference. For example, if a data object has high sale price in the network transaction system, when the virtual item is generated, more virtual resources are associated. Certainly, the virtual resource correlated with the virtual item may be irrelevant with the price of the data objects in the network transaction system, which is not limited herein.

In addition, among many information publishing subsystems, there is a special type of information publishing subsystem, which is referred to as a “network broadcast system.” In such platform, some users play “anchor” role in the platform in the form of live broadcast of some audio or video information, and interact with other users within the platform. Each “anchor” may have a different virtual space (which is generally called “room”) opened by the platform. Correspondingly, the audience may enter their own room of interest to interact with the corresponding anchor. In the process of interaction, a user of the audience may send gifts to the anchor, and the other users may view the gifts received by the anchor, etc. That is, in this case, the users in the platform are divided into user groups in different virtual spaces and users in the same virtual space interact with each other. In the same virtual space, the audience may also show different group features according to the gender, age and broadcast content of the “anchor”. Therefore, when the data objects are placed, they may be placed based on virtual space as units.

In actual implementation, the network broadcast usually has the following features: First, the “anchor user” in the platform generally belongs to a relatively fixed user group in the system, and these users usually need to perform identity authentication and the like, and the system provides them with permission to be “anchors” The anchors then start live video broadcasting in the virtual space. Second, the virtual space that an anchor user enters each time is not fixed, that is, anchor users and virtual spaces usually do not have a binding relationship. In order to improve the utilization of resources, a specific virtual space is created usually after the anchor submits a request. Third, for the “audience users” accessing to the network broadcast system, such users may choose to enter the virtual space of an anchor that is currently online, and in the subsequent interaction with the server, the identification of the virtual space may be usually carried with the user while the identification of the anchor associated with the virtual space is generally not carried with the user.

Based on the above features, in this example embodiment of the present disclosure, data object placement by using a virtual space as a unit may be implemented in the following manner. The server of the network broadcast system may send information of the anchor users (which may be referred to as the second users in this example embodiment), which is a relatively fixed user group, to the access subsystem so that the access subsystem may provide a list of second users included in the unified network broadcast system when providing the selectable placement channels list. At the same time, the access subsystem may also provide the information of each second user, including gender, age, preferences and so on. In this way, when the data object placement party performs the data object placement, a specific second user is selected for the data object placement. In the process of using the specific virtual items, after creating the virtual space, the second user client terminal may notify the access subsystem of the created virtual space and related second user information and first user information through the SDK or directly invoking the interface of the access subsystem (such information may be transmitted to the access subsystem directly through the client terminal, or the access subsystem may obtain such information from the client terminal of the third party live broadcast platform through the room ID.) Thus, when the first user client terminal associated with the virtual space submits a request to obtain the data object information, the access subsystem extracts the data object list corresponding to the second user associated with the virtual space accordingly and returns the data object list to the first user client terminal. The first user client terminal generates the virtual item accordingly.

That is, in this case, the information stored in the access subsystem may be as shown in Table 2:

TABLE 2

| ID of | Name of | | | |
|---|---|---|---|---|
| Information | Information | ID of | | |
| Publishing | Publishing | Virtual | Information of | |
| Subsystem | Subsystem | Space | Anchor user | Data Object List |
| 100001 | Platform A | 20001 | Information of | Data object a11, |
| | | | anchor user A | data object a12, |
| | | | | . . . |
| | | 20002 | Information of | Data object a21, |
| | | | anchor user B | data object a22, |
| | | | | . . . |
| | | . . . | . . . | . . . |
| 100002 | Platform B | 30001 | Information of | Data object b11, |
| | | | anchor user C | data object b12, |
| | | | | . . . |
| | | 30002 | Information of | Data object b21, |
| | | | anchor user D | data object b22, |
| | | | | . . . |
| | | . . . | . . . | . . . |
| . . . | . . . | . . . | . . . | . . . |

In this way, when receiving a request for sending a virtual item, the client terminal may submit the identification of the current information publishing subsystem and the identification of the current virtual space to the access subsystem. The access subsystem may return the data object list corresponding to the virtual space. Thus, the user may select from the virtual items and send them to the anchor user of the current virtual space. The other users in the virtual space may view the virtual item generated according to the data object from the virtual item list received by the anchor user, click to view the details of the virtual items, and even jump to the client terminal of the network transaction system to make order and purchase. In short, in this way, data objects are placed per virtual space, which makes the data objects placement more accurate and further improves the effectiveness of the data objects.

In conclusion, with the example embodiments of the present disclosure, the virtual item display and the sending function in the information publishing subsystem are used as the placement channels for the data objects. In this way, the presentation forms of the virtual item in the information publishing subsystem are abundant, and the placement channels of the data objects are rich. In addition, as the processing of sending the virtual item is an actively participating behavior of the user. Thus, compared with the compulsory advertisement placement or in-stream, the user will have higher acceptance degrees to such process of sending the virtual item. When the click through rate and conversion rate of the data objects are increased, the user experience is improved.

As shown from the foregoing descriptions, in the second example embodiment of the present disclosure, multiple parties may cooperate with each other, which include the open platform's access subsystem, the information publishing subsystem, the data object placement subsystem, and the like. The information publishing subsystem may further include a back-end server and a front-end client terminal. The client terminal may also be different according to a role played by a user. A user who needs to send a virtual item in the platform may be referred to as a “first user” in the information publishing subsystem. A recipient user of the virtual item (i.e., the information publisher user or the foregoing “anchor user”) is referred to as a “second user.” Another user that accesses the information publishing page of the second user is referred to as a “third user.” Certainly, the above first user, second user, or third user mentioned above does not refer to a certain fixed user, and identities of the same user in the platform may be converted. In this example embodiment of the present disclosure, the identity of the user is classified in the same process of sending virtual item.

The following describes an implementation process from various perspectives through various specific embodiments.

A third example embodiment:

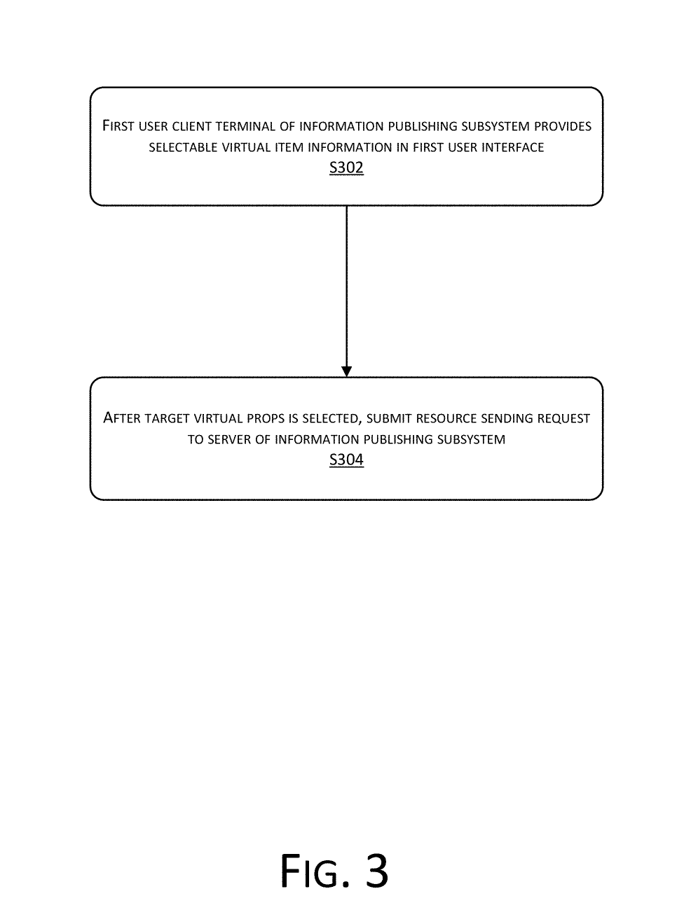

The third embodiment provides a data object information processing method mainly from the perspective of a first user client terminal (that is, a sender user client terminal of a virtual item) of the information publishing subsystem. Referring to FIG. 3, the method may include the following steps:

S302: A first user client terminal of the information publishing subsystem provides selectable virtual item information at a first user interface. The first user interface further includes information published by a second user client terminal of the information publishing subsystem. The virtual item is generated according to data object information that is pre-placed in the information publishing subsystem.

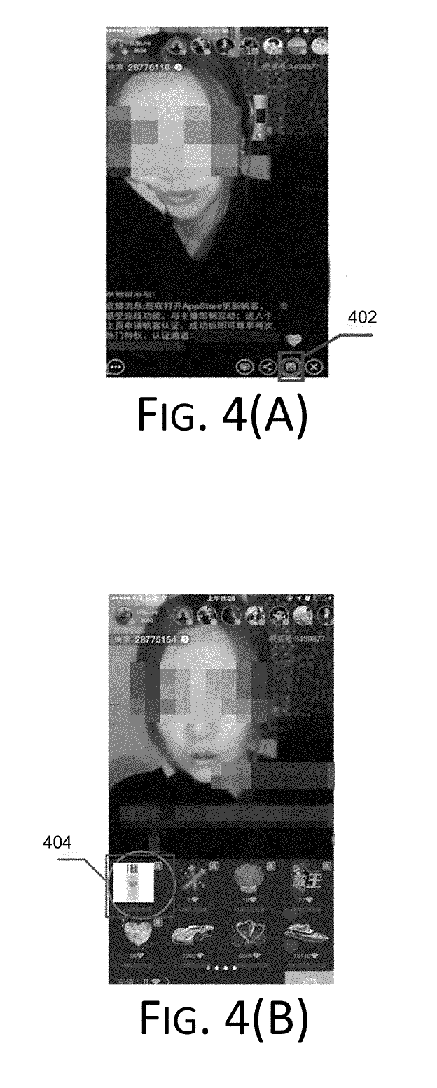

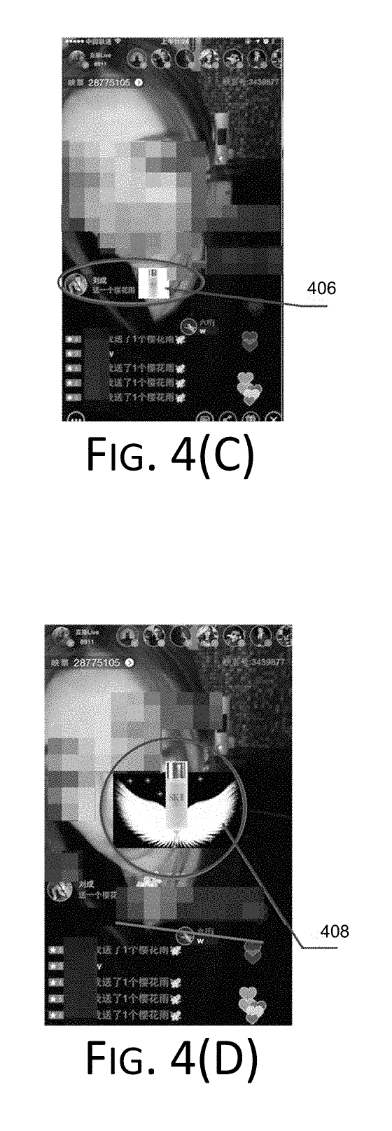

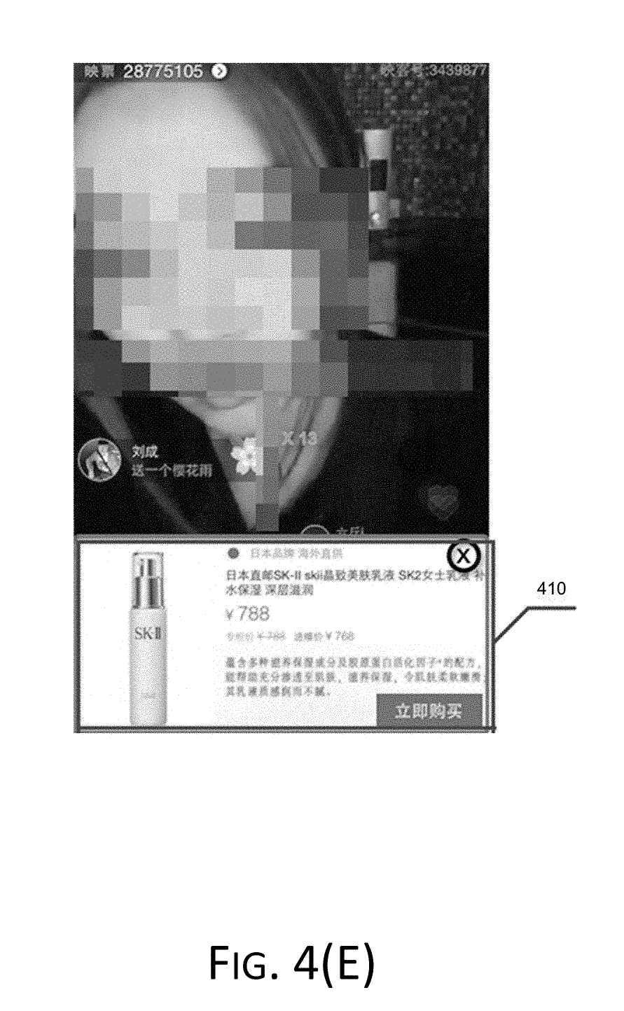

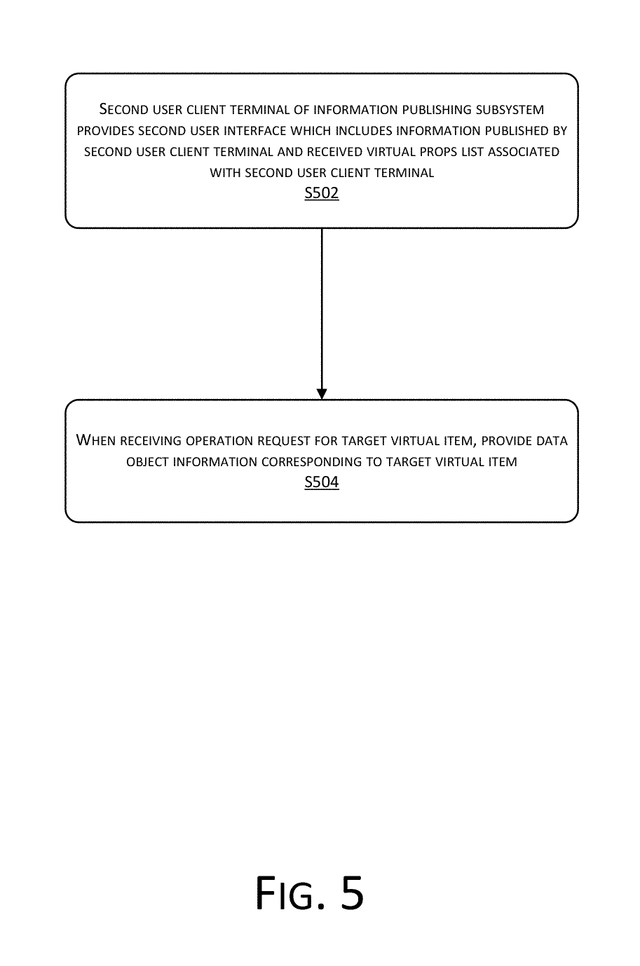

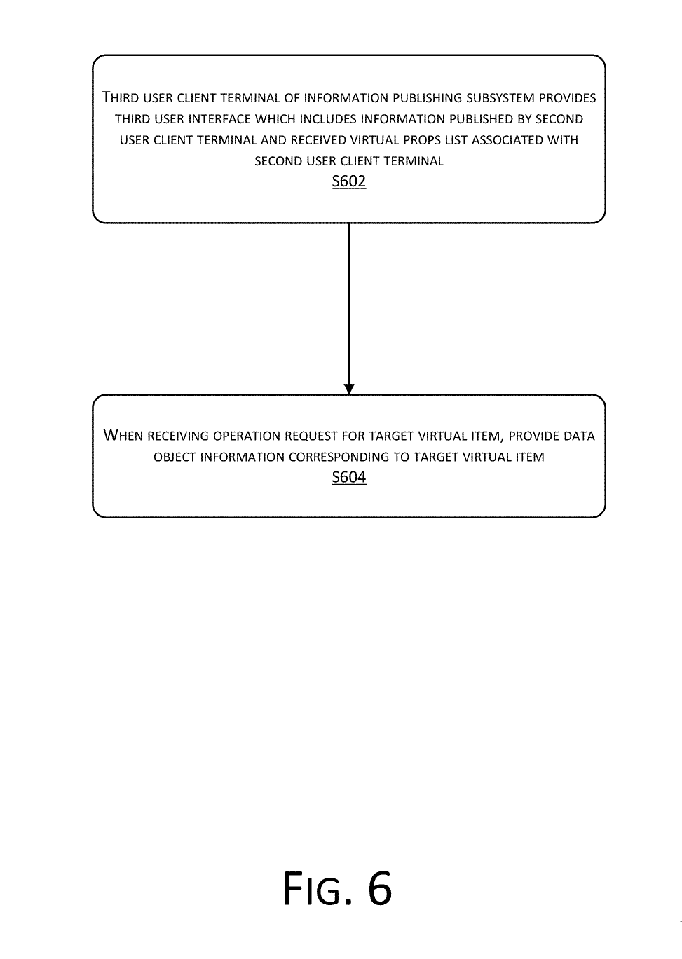

In specific implementation, the client terminal in the information publishing subsystem may provide the first user interface according to the user request, which may display the information posted by the second user client terminal of the information publishing subsystem such as video, audio, picture, article, etc. The specific form of information publishing may be real-time, pre-recorded or edited and then publish, and so on. In such a first user interface, operation options for sending virtual items may be provided, for example, in the form of buttons or the like. Specifically, as shown at 404 in the interface shown in FIG. 4(A), a button may be displayed in the form of a picture such as “gift box”. When the user clicks the button, the first user client terminal may provide selectable virtual items information. If the data object placed in the information publishing subsystem is determined in advance and is fixed, a virtual item may be generated by the server of the information publishing subsystem according to the data object information in advance and placed to the client terminal. A first user client terminal directly displays the virtual item. Alternatively, the first user client terminal may submit a request for obtaining the virtual item list information to the server of the information publishing subsystem, and provide the virtual item information according to the information returned by the server, which includes the virtual item generated according to the data object information.

More often, the corresponding relationship between the information publishing subsystem and the data object is stored in the access subsystem. In this case, the first user client terminal firstly communicates with the access subsystem and is provided by the access subsystem with data object information, then, based on the data object information, generates a virtual item, and adds the virtual item to the list of candidate virtual items. For example, as shown in FIG. 4(B), in the virtual item list, a virtual item generated according to the data object of a lotion class shown in 404 may be included, and the user may use this virtual item to send a gift to the second user, and may prompt the user to “select this virtual item for play reward”, and so on.

That is, in specific implementation, the first user client terminal submits a request for obtaining virtual item information to a preset access subsystem, which carries the identification of the corresponding information publishing subsystem. The access subsystem determines, according to the identification of the information publishing subsystem, the corresponding data object information and returns the data object information. The first user client then generates the virtual item according to the data object information returned by the access system, and provides the virtual item at the first user interface.

The information publishing subsystem includes a network broadcast system. In this case, the information published by the second user client terminal includes the network broadcast information published by the second user client terminal. In this case, the concept of virtual space may exist. The access subsystem may store data object information corresponding to each of multiple virtual spaces in the network broadcast system. Therefore, when receiving the request for sending the virtual resource information to the second user client terminal, the first user client terminal sends a request for obtaining the associated data object information to the access subsystem, and carries the identification of the network broadcast system and the identification of the current virtual space in the request. In turn, the selectable virtual item information may be generated according to the data object information corresponding to the currently located virtual space that is returned by the access subsystem.

S304: After a target virtual item is selected, a resource sending request is submitted to a server of the information publishing subsystem. The server adds the target virtual item to the received virtual item list associated with the second user client terminal.

In specific implementation, the virtual item may also be associated with virtual resource information. When the server adds the target virtual item to the received virtual item list that is associated with the second user client terminal, the virtual resource is transferred to the virtual account associated with the second user client terminal according to the virtual resource information associated with the target virtual item.

In addition, the virtual item is associated with front-end display information for display in the list of candidate virtual items. For example, such information may be in the form of an image. At this time, if the data object includes a product object published in a preset network transaction system, the front-end display information corresponding to the target virtual item may include the representative image information of the product object.

In addition, in an implementation, referring to FIG. 4(C), a received virtual item list associated with the second user client terminal may also be displayed at the first user interface, as shown at 406, which includes the virtual item generated according to the data object information. Such virtual items may be displayed in a static form, or a dynamic form such as a display of an animation, as shown in FIG. 4(D). When the target virtual item in the received virtual item list is operated, as shown at 410 in FIG. 4(E), the information of the data object corresponding to the target virtual item may also be provided in the preset network transaction system, such as the name, price, inventory, and brief introduction information of the product. In addition, the information of the data object in the preset network transaction system may further include a detail link of the data object in the preset network transaction system may also include a link to detailed information of the data object in the preset network transaction system. When the link to detailed information is operated, according to the network address corresponding to the link, the details page of the data object in the preset network transaction system is provided

Specifically, there may be multiple manners when providing the details page of the data object in the preset network transaction system. For example, information such as the name in the network transaction system may be extracted from the link to detailed information. For instance, if the data object is in “Taobao,” the domain name of the link address may be “taobao.com”, and so on. Based on the name information, whether the first user client terminal has installed the client terminal of the preset network transaction system is determined. If the terminal device of the first user client terminal already installs the client terminal of the preset network transaction system, the client terminal of the preset network transaction system is opened to display the details page. After the client terminal of the network transaction system is opened, specific operations such as purchase and payment may also be performed. If the terminal device of the first user client terminal does not install the client terminal of the preset network transaction system, the browser installed at the terminal device is opened to open a corresponding link address, or a browser embedded into the first user client terminal is opened to open the corresponding link address. No matter which manner is used to open to the details page, click volume is brought to the network transaction system. If the user finally conducts purchase operation, the page conversion is achieved. It should be noted that, for the data object placed in the information publishing subsystem, the identification of the information publishing subsystem may be combined into the Uniform Resource Locator (URL). Thus, the network transaction system tracks the source of the traffic for following related operations such as traffic source statistics.

As there are often multiple second users in the information publishing subsystem, the second users are the information publisher user in the information publishing subsystem. For example, in the live broadcast platform, some users may register as “anchor.” Such anchor users are the second user in this example embodiment of the present disclosure. Therefore, in this example embodiment of the present disclosure, when the data objects are placed for the information publishing subsystem, or the server of the information publishing subsystem selects the data objects used to generate the virtual item, the data objects may be placed or selected by using each second user as a unit. That is, different second user in the information publishing subsystem may correspond to different data object information. When the first user client terminal needs to display the virtual item list, the need to display the virtual item list usually happens after the first user client terminal establish an association with a respective second user, such that the first user client terminal enters a live broadcast room of the respective second user.

In the system architecture described in the second embodiment, a request for obtaining data object information is sent to the access subsystem, wherein the request carries an identification of the information publishing subsystem and information for identifying a target second user, so that the access subsystem returns the data object information corresponding to the target second user. The virtual item is generated according to the data object information corresponding to the target second user returned by the access subsystem.

The information publishing subsystem includes a network broadcast system, and the information published by the second user client terminal includes network broadcast information published by the second user client terminal. After the second user enters the virtual space, the second user client terminal submits the corresponding relationship between the second user identification and the virtual space identification to the access subsystem. In this case, the information carried in the request for identifying the target second user may include the identification of the virtual space associated with the first user client terminal so that the access subsystem determines the identification of the target second user according to the identification of the virtual space and the corresponding relationship.

Alternatively, under the system architecture of the first example embodiment, different data object information corresponding to different second users may also be saved on the server of the information publishing subsystem. The first user client terminal sends a request for obtaining data object information to the server, and the server returns data object information corresponding to the target second user. Then, the first user client terminal generates the virtual item according to the data object information corresponding to the second user returned by the server.

A fourth example embodiment:

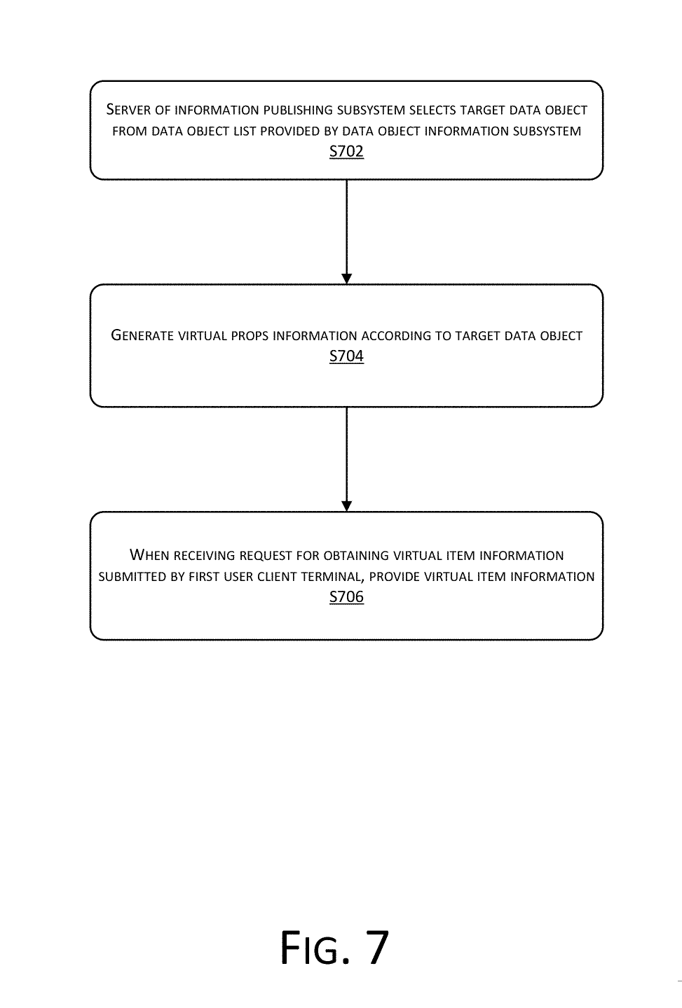

In the fourth example embodiment, a method for providing data object information is provided from the perspective of a second user client terminal. Referring to FIG. 5, the method may s include the following steps:

S502: A second user client terminal of the information publishing subsystem provides a second user interface. The second user interface includes information published by the second user client terminal and the received virtual item list that is associated with the second user client terminal. The received virtual item list includes a target virtual item generated according to a preset data object.

S504: When receiving an operation request for the target virtual item, the data object information corresponding to the target virtual item is provided.

That is, the second user client terminal, as the recipient of the virtual item, may also display the virtual item list has been received, and the second user may perform an operation such as clicking on the virtual item. The second user client terminal further provides corresponding data object information.

In an implementation, the information publishing subsystem includes a network broadcast system. In this case, after creating the virtual space for the second user, the second user client terminal may further submit the corresponding relationship between the identification of the second user and the identification of the virtual space to the access subsystem. The access subsystem records the corresponding relationship, determines the corresponding identification of the second user according to the identification of the virtual space carried in the request, and returns the data object information corresponding to the identification of the second user to the first user client terminal. The first user client terminal generates the virtual item according to the data object information to send to the second user client terminal corresponding to the target virtual space.

A fifth example embodiment:

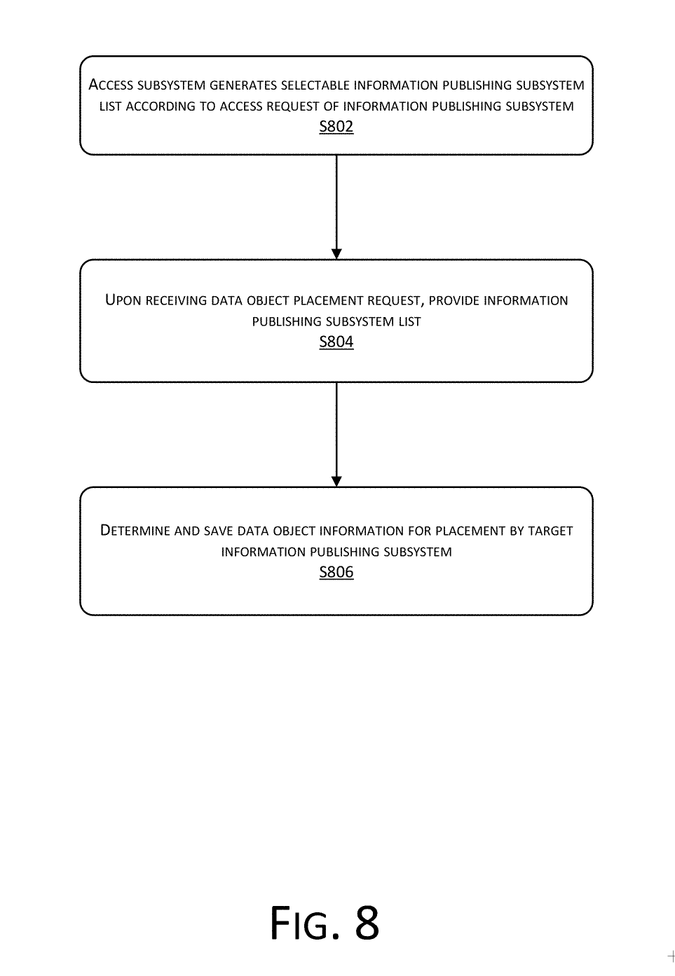

In the fifth example embodiment, a method for providing data object information is provided from the perspective of a third user client terminal. Referring to FIG. 6, the method may include the following steps:

S602: A third user client terminal of the information publishing subsystem provides a third user interface. The third user interface includes information published by a second user client terminal and the received virtual item list associated with the second user client terminal. The received virtual item list includes a target virtual item generated according to a preset data object.

S604: When an operation request for the target virtual item is received, the data object information corresponding to the target virtual item is provided.

That is, although the third user client terminal is neither the sender of the virtual item nor the receiver of the virtual item. As the “audience”, when accessing the information published by the second user client terminal, the third user client terminal also views which virtual items have been received by the second user client terminal. During the process that the third user client terminal views the virtual item, if there is an operation such as click to the virtual item, the third user client terminal also provides the corresponding data object information.

A sixth example embodiment:

The sixth example embodiment corresponds to the first example embodiment, and provides a method for providing data object information from the perspective of the server of the information publishing subsystem. Referring to FIG. 7, the method may include the following steps:

S702: The server of the information publishing subsystem selects the target data object from the data object list provided by the data object information subsystem.

S704: The virtual item information is generated according to the target data object.

S706: When the request for obtaining virtual item information submitted by the first user client terminal is received, the virtual item information is provided.

The first user client terminal provides the virtual item information at the user interface.

When determining the target data object, corresponding target data object information may be respectively selected for each second user for a plurality of second users at the server of information publishing subsystem. When the virtual item information is provided, and the request for obtaining the virtual item information submitted by the first user client terminal is received, the second user associated with the first user client terminal is determined and the virtual item information corresponding to the second user is provided.

A seventh example embodiment:

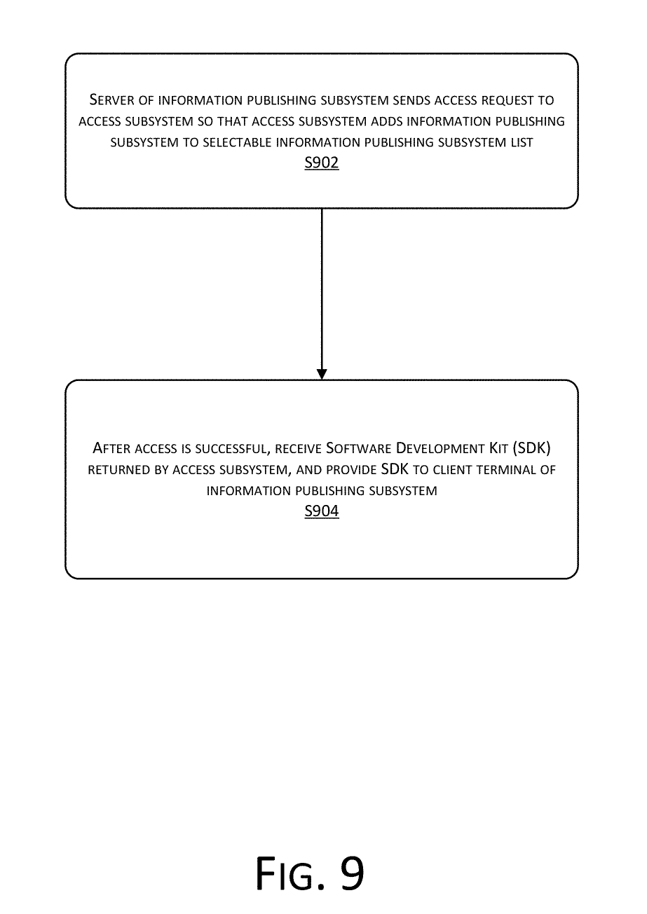

The seventh example embodiment corresponds to the system architecture provided in the second example embodiment, and mainly provides a method for providing data object information from an access subsystem perspective. Referring to FIG. 8, the method may include the following steps:

S802: The access subsystem generates a selectable information publishing subsystem list according to an access request of an information publishing subsystem.

S804: when a data object placement request is received, the information publishing subsystem list is provided.

S806: The data object information for placement by the target information publishing subsystem is determined and saved. When the first user client terminal of the information publishing subsystem submits the request for obtaining the data object information, the data object information corresponding to the information publishing subsystem is returned to the first user client terminal. The first user client terminal generates the virtual item according to the data object information.

In an implementation, in order to achieve more accurate placement, when the information publishing subsystem list is provided, information attributes and/or audience user group features published in the information publishing subsystem are determined. The information attribute and/or audience user group features published in the information publishing subsystem are provides so that the data object is placed to the corresponding information publishing subsystem according to the information attribute and/or audience user group features.

Alternatively, the information attribute and/or audience user group features published in the information publishing subsystem are determined. The data object features matching the information publishing subsystem are determined according to the information attribute and/or audience user group features published in the accessed information publishing subsystem. When the information publishing subsystem list is provided, the matching data object features corresponding to each information publishing subsystem are provided so that the data objects are placed to the corresponding information subsystem according to the data object features.

In addition, identification information of a plurality of different second users in the information publishing subsystem may also be determined. When the information publishing subsystem list is provided, second user list information corresponding to each information publishing subsystem is also provided so that the placement of the data object information is performed by using each second user as a unit, and the corresponding relationship between the identification of the second user and the data object information is saved.

Specifically, the information attribute published by each second user and/or audience user group feature information may also be determined. When the second user list information corresponding to each information publishing subsystem is provided, the information attribute and/or the audience user group feature information are also provided so that the data object information is placed according to the information attribute and/or audience user group feature information.

An eighth example embodiment:

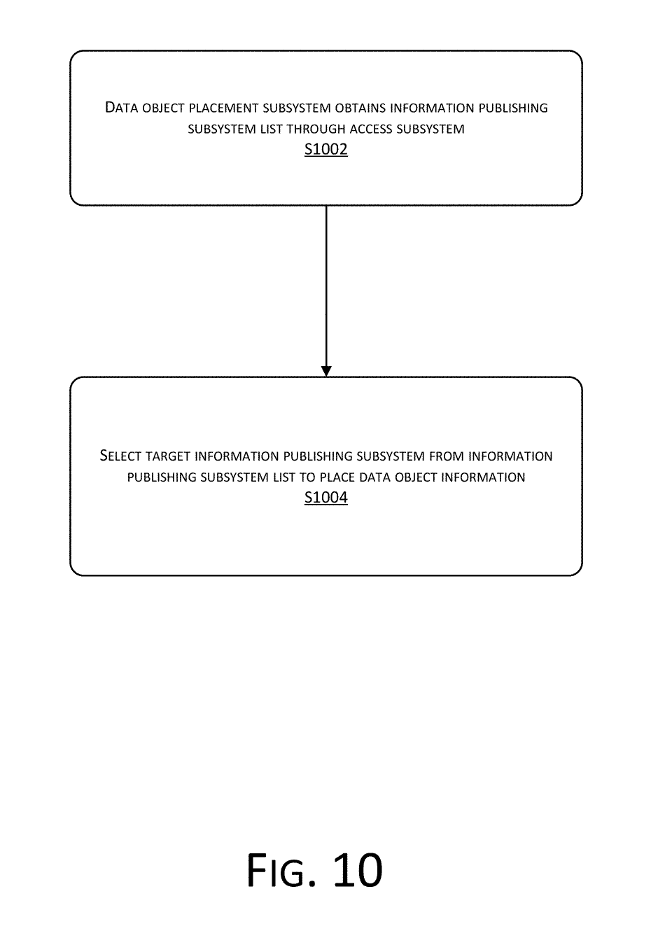

The eighth example embodiment also corresponds to the system architecture provided in the second example embodiment, and provides a method for providing data object information from the perspective of the server of the information publishing subsystem server. Referring to FIG. 9, the method may include the following steps:

S902: The server of the information publishing subsystem sends an access request to the access subsystem, so that the access subsystem adds the information publishing subsystem to the selectable information publishing subsystem list, and upon receiving the data object placement request, provides the information publishing subsystem list and places the data object to the information publishing subsystem.

S904: After access is successful, the SDK returned by the access subsystem is received, and the SDK package is provided to the client terminal of the information publishing subsystem. The client terminal of the information publishing subsystem establishes the information interaction channel with the access subsystem by installing the SDK package, obtains a data object list corresponding to the information publishing subsystem from the access subsystem, and generates a virtual item according to the data object information.

In an implementation, the server may further provide the access subsystem with the information attributes and/or audience user group feature information published in the information publishing subsystem, so that the access subsystem provides the published information attributes and/or audience user group features information when providing the selectable information publishing subsystem list.

Alternatively, the access subsystem may also be provided with the second user list information in the information publishing subsystem, information attributes published by each second user, and/or audience user group features, so that the access subsystem, when providing the selectable information publishing subsystem list, also provides the second user list information, information attributes published by each second user, and/or audience user group features.

A ninth example embodiment:

The ninth example embodiment also corresponds to the system architecture provided in the second example embodiment. Referring to FIG. 10, the method may include:

S1002: The data object placement subsystem obtains the information publishing subsystem list through the access subsystem.

S1004: A target information publishing subsystem is selected from the information publishing subsystem list to place data object information. The access subsystem stores the corresponding relationship between the information publishing subsystem and the data object information, so that the first user client terminal in the information publishing subsystem generates the virtual item information according to the corresponding data object information.

Regarding the foregoing third example embodiment to the ninth example embodiment, the detailed implementations may refer to the descriptions in the first and second example embodiments, which are not detailed herein.

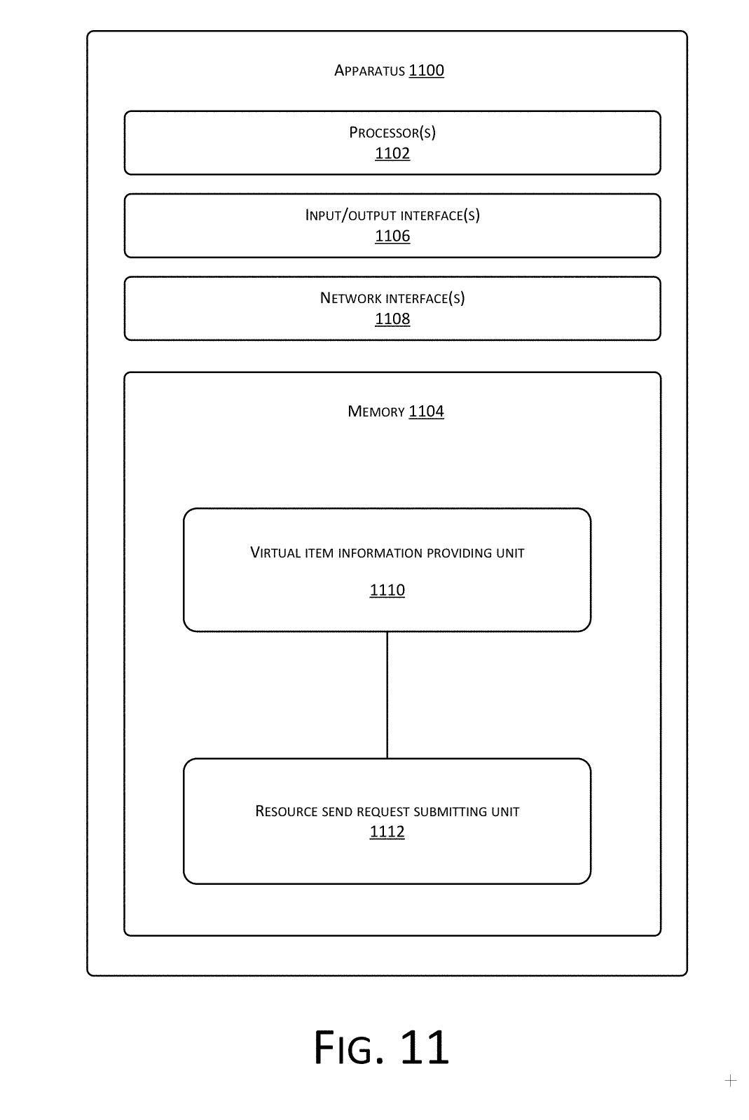

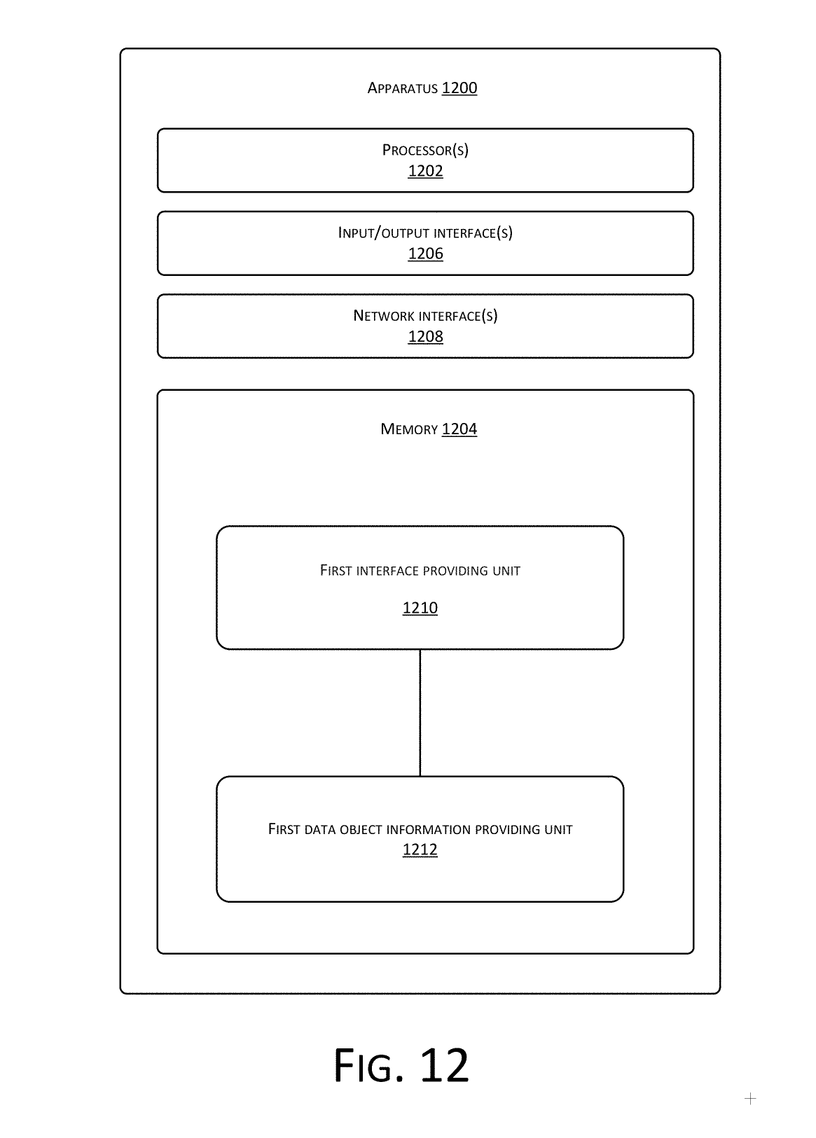

Corresponding to the third example embodiment, the present disclosure also provides an apparatus for processing data object information. Referring to FIG. 11, an apparatus 1100 is applied to a first user client terminal in an information publishing subsystem.

The apparatus 1100 includes one or more processor(s) 1102 or data processing unit(s) and memory 1104. The apparatus 1100 may further include one or more input/output interface(s) 1106 and one or more network interface(s) 1108. The memory 1104 is an example of computer readable media.

Computer readable media, including both permanent and non-permanent, removable and non-removable media, may be stored by any method or technology for storage of information. The information can be computer readable instructions, data structures, modules of programs, or other data. Examples of computer storage media include, but are not limited to, phase change memory (PRAM), static random access memory (SRAM), dynamic random access memory (DRAM), other types of random access memory (RAM), read only memory Such as ROM, EEPROM, flash memory or other memory technology, CD-ROM, DVD, or other optical storage, Magnetic cassettes, magnetic tape magnetic tape storage or other magnetic storage devices, or any other non-transitory medium, may be used to store information that may be accessed by a computing device. As defined herein, computer-readable media do not include non-transitory transitory media such as modulated data signals and carriers.

The memory 1104 may store therein a plurality of modules or units including:

a virtual item information providing unit 1110 that provides selectable virtual item information at a first user interface, wherein the first user interface further includes information published by a second user client terminal of the information publishing subsystem, and the virtual item is generated according to the data object information; and

a resource sending request submitting unit 1112 that submits a resource sending request to a server of the information publishing subsystem after the target virtual item is selected, and the server adds the target virtual item to the received virtual item list associated with the second user client terminal.

In an implementation, the virtual item information providing unit may submit a request for obtaining virtual listing list information to the server of the information publishing subsystem, and provide the virtual item information according to the information returned by the server, which includes the virtual item generated according to the data object information.

Alternatively, when the corresponding relationships between the multiple information publishing subsystems and the data object information are stored by a unified access subsystem, the virtual item information providing unit may submit a request for obtaining virtual item information to the preset access subsystem, which carries an identifier of a corresponding information publishing subsystem. The access subsystem determines corresponding data object information according to the identification of the information publishing subsystem and returns the data object information. The virtual item is generated according to the data object information returned by the access subsystem and provided at the first user interface.

The virtual item is associated with virtual resource information. When the server adds the target virtual item to the received virtual item list that is associated with the second user client terminal, the server further transfers the virtual resource to the virtual account associated with the second user client terminal according to the virtual resource information associated with the target virtual item.

In an implementation, the virtual item may also be associated with front-end presentation information for display in the candidate virtual item list.

The data object may include a product object published in a preset network transaction system, and the front-end display information corresponding to the target virtual item may be generated according to the representative image information of the product object.

In an implementation manner, the apparatus may further include:

a virtual item list displaying unit that displays, at the first user interface, the received virtual item list associated with the second user client terminal; and

a data object information providing unit that provides information of the data object corresponding to the target virtual item in the preset network transaction system when the target virtual item in the received virtual item list is operated.

The information of the data object in the preset network transaction system may include a detail link of the data object in the preset network transaction system, and the apparatus may further include a details page providing unit that provides a details page of the data object in the preset network transaction system when the detail link is operated according to the network address corresponding to the detail link.

Specifically, the details page providing unit may open the client terminal of the preset network transaction system to display the details page when the terminal device of the first user client terminal already installs the preset network transaction system.

In an implementation, different second users in the information publishing subsystem correspond to different data object information, and the second user is an information publisher user in the information publishing subsystem.

The virtual item information providing unit may further, after the first user client terminal establishes an association with the target second user, determine data object information corresponding to the target second user; and generate the virtual item according to the data object information corresponding to the target second user.

The corresponding relationship between the multiple information publishing subsystems and the data object information may be stored by a unified access subsystem, and different second users in the same information publishing subsystem correspond to different data object information.

The virtual item information providing unit may further send a request for obtaining data object information to the access subsystem, which carries an identification of the information publishing subsystem and information for identifying the target second user, so that the access subsystem return the data object information corresponding to the target second user. The virtual item information providing unit generates the virtual item according to the data object information corresponding to the target second user that is returned by the access subsystem.

In a specific application, the information publishing subsystem includes a network broadcast system, and the information published by the second user client terminal includes network live broadcasting information published by the second user client terminal. The second user client terminal, after the second user enters the virtual space, submits the corresponding relationship between the identification of the second user and the identification of the virtual space to the access subsystem.

In this case, the information for identifying the target second user that is carried in the request may include an identification of the virtual space that is associated with the first user client terminal, so that the access subsystem determines, according to the identification of the virtual space and the corresponding relationship, the identification of the target second user.

In another implementation manner, different data object information corresponding to different second users may be stored on the server of the information publishing subsystem. In this case, the virtual item information providing unit may send a request for obtaining data object information to the server. The server returns the data object information corresponding to the target second user. The virtual item information providing unit generates the virtual item according to the data object information corresponding to the second user returned by the server.

Corresponding to the fourth example embodiment, the present disclosure also provides an apparatus for processing data object information. Referring to FIG. 12, an apparatus 1200 is applied to a second user client terminal in an information publishing subsystem.

The apparatus 1200 includes one or more processor(s) 1202 or data processing unit(s) and memory 1204. The apparatus 1200 may further include one or more input/output interface(s) 1206 and one or more network interface(s) 1208. The memory 1204 is an example of computer readable media.

The memory 1204 may store therein a plurality of modules or units including:

a first interface providing unit 1210 that provides a second user interface, wherein the second user interface includes the information published by the second user client terminal and the received virtual item list that is associated with the second user client terminal, and the received virtual item list includes a target virtual item generated according to a preset data object; and

a first data object information providing unit 1212 that provides information of a data object corresponding to the target virtual item when receiving an operation request for the target virtual item.

In an implementation, the information publishing subsystem includes a network broadcast system, and the apparatus may further include a corresponding relationship submitting unit that submit a corresponding relationship between the identification of the second user and the identification of the virtual space to an access subsystem after the second user client terminal creates a virtual space for the second user. The subsystem records the corresponding relationship, determines the identification of the corresponding second user according to the identification of the virtual space carried in the request when the first user client terminal submits the request for obtaining the data object information, and returns the data object information corresponding to the identification of the second user to the first user client terminal. The first user client terminal generates a virtual item according to the data object information to send the virtual item to the second user client terminal corresponding to the target virtual space.

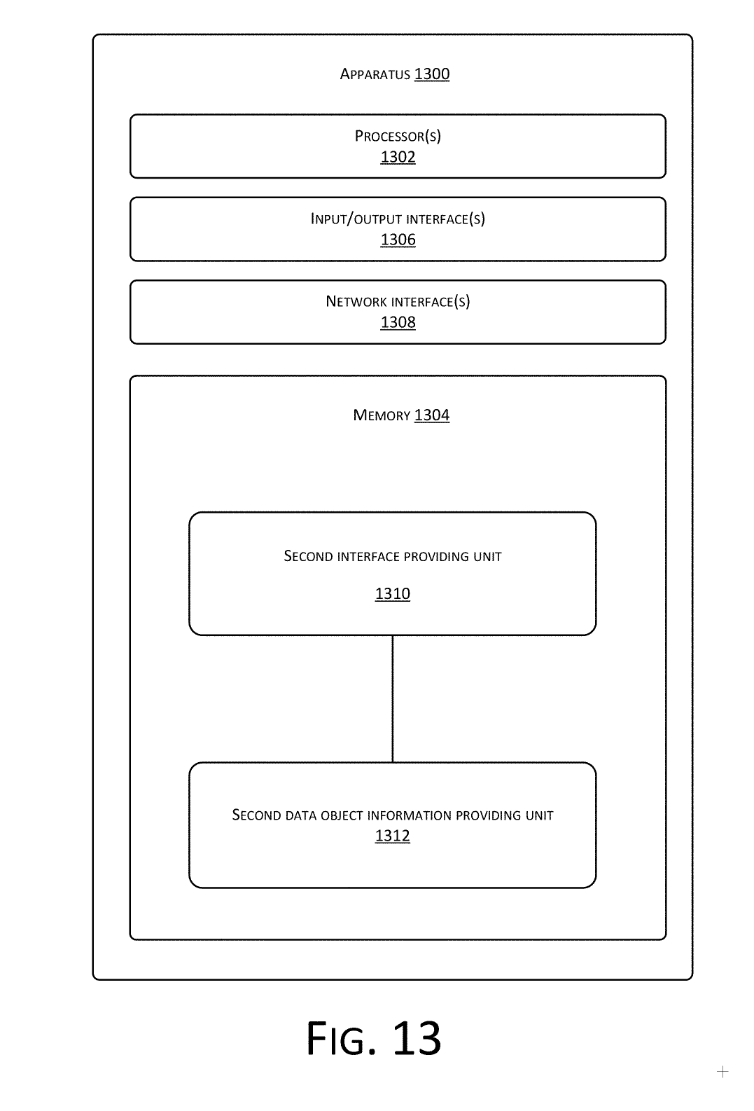

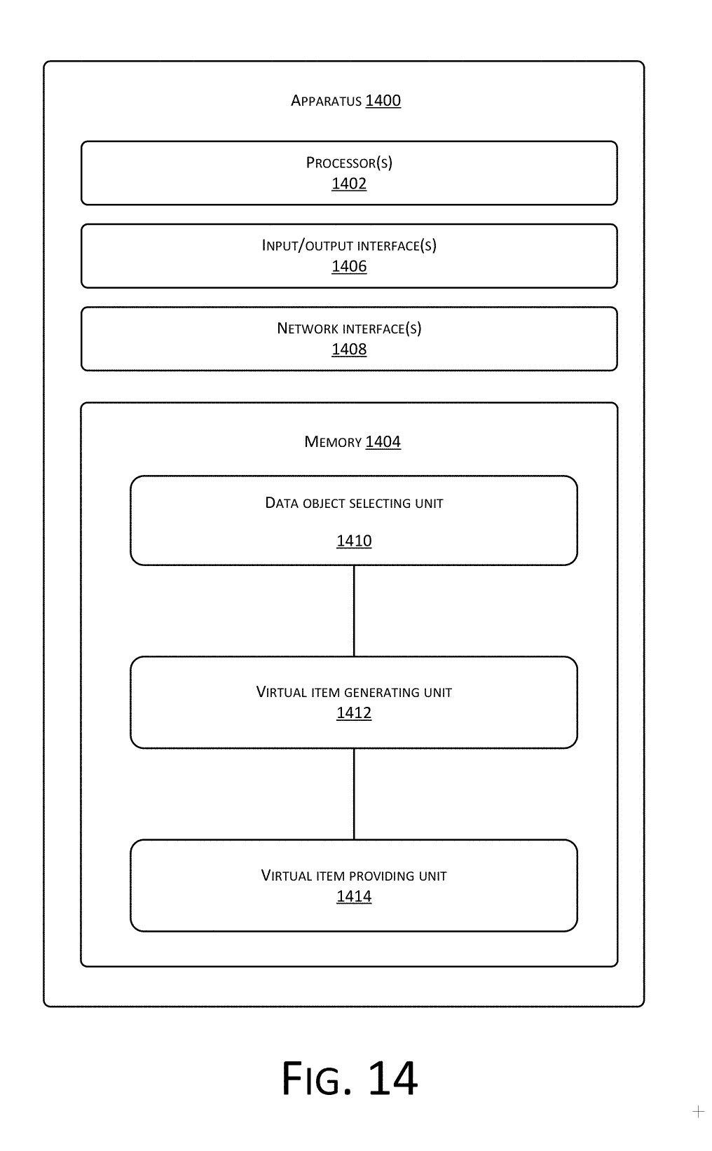

Corresponding to the fifth example embodiment, the present disclosure also provides an apparatus for processing data object information. Referring to FIG. 13, an apparatus 1300 is applied to a third user client terminal in an information publishing subsystem.

The apparatus 1300 includes one or more processor(s) 1302 or data processing unit(s) and memory 1304. The apparatus 1300 may further include one or more input/output interface(s) 1306 and one or more network interface(s) 1308. The memory 1304 is an example of computer readable media.

The memory 1304 may store therein a plurality of modules or units including:

a second interface providing unit 1310 that provides a third user interface, wherein the third user interface includes information published by a second user client terminal and a received virtual item list that is associated with the second user client terminal, and the received virtual item list includes a target virtual item generated according to a preset data object; and

a second data object information providing unit 1312 that provides data object information corresponding to the target virtual item when receiving an operation request for the target virtual item.

Corresponding to the sixth example embodiment, the present disclosure further provides an apparatus for processing data object information. Referring to FIG. 14, an apparatus 1400 is applied to a server of an information publishing subsystem.

The apparatus 1400 includes one or more processor(s) 1402 or data processing unit(s) and memory 1404. The apparatus 1400 may further include one or more input/output interface(s) 1406 and one or more network interface(s) 1408. The memory 1404 is an example of computer readable media.

The memory 1404 may store therein a plurality of modules or units including:

a data object selecting unit 1410 that selects the target data object from the data object list provided by the data object information subsystem;

a virtual item generating unit 1412 that generates virtual item information according to the target data object. and

a virtual item providing unit 1414 that provides the virtual item information when receiving the request for obtaining the virtual item information submitted by the first user client terminal and provides the virtual item information so that the first user client terminal provides the virtual item information at the user interface.

The data object selecting unit may multiple second users for the information publishing subsystem and selects the target data object information corresponding to each second user respectively.

The virtual item providing unit may determine the second user associated with the first user client terminal when receiving the request for obtaining virtual item information submitted by the first user client terminal, and provide the virtual item information corresponding to the second user.

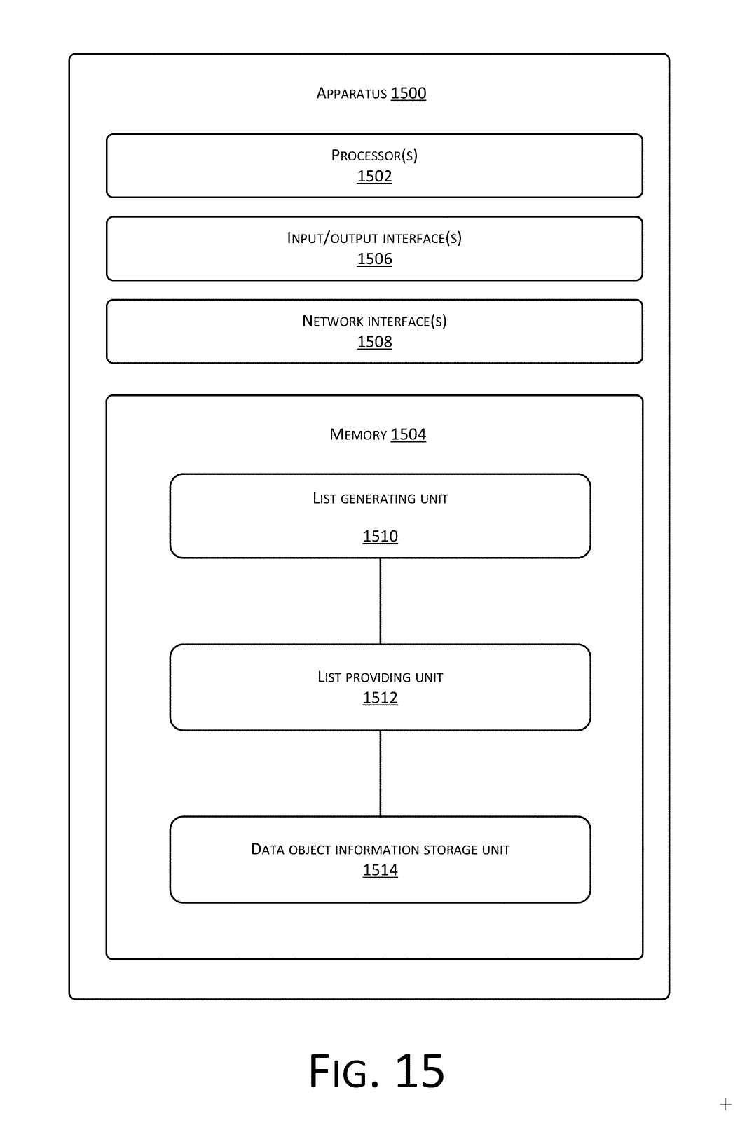

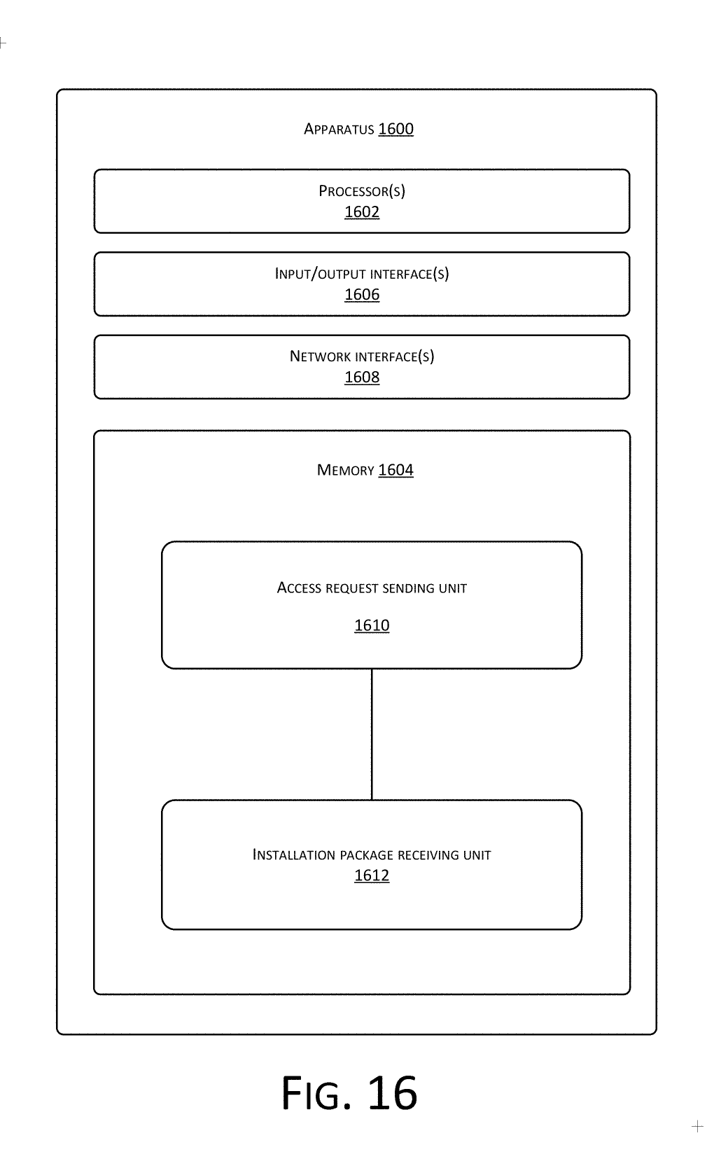

Corresponding to the seventh example embodiment, the present disclosure further provides an apparatus for processing data object information. Referring to FIG. 15, an apparatus 1500 is applied to an access subsystem.

The apparatus 1500 includes one or more processor(s) 1502 or data processing unit(s) and memory 1504. The apparatus 1500 may further include one or more input/output interface(s) 1506 and one or more network interface(s) 1508. The memory 1504 is an example of computer readable media.

The memory 1504 may store therein a plurality of modules or units including:

a list generating unit 1510 that generates a selectable information publishing subsystem list according to an access request of the information publishing sub-system;

a list providing unit 1512 that provides the information publishing subsystem list when receiving the data object placement request; and

a data object information storing unit 1514 that determines and stores the data object information for the target information publishing subsystem, returns the data object information corresponding to the information publishing subsystem to the first user client terminal when the first user client terminal of the information publishing subsystem submits the request for obtaining the data object information so that the first user client terminal generates the virtual item according to the data object information.

In an implementation, the apparatus may further include:

a first information determining unit that determines information attributes and/or audience user group feature information published in the information publishing subsystem; and

a feature information providing unit that provides the information attribute and/or audience user group feature information published in the information publishing subsystem when the information publishing subsystem list is provided to place the data object to the corresponding information publishing subsystem according to the information attribute and/or audience user group feature information.

In addition, the apparatus may further include:

a second information determining unit that determines information attributes and/or audience user group feature information published in the information publishing subsystem;

a data object feature determining unit that determines, according to the information attribute and/or audience user group feature information published in the accessed information publishing subsystem, the data object feature matching the information publishing subsystem; and

a data object feature providing unit that provides the matched data object features corresponding to the respective information publishing subsystems when the information publishing subsystem list is provided and places the data objects, according to the data object features, to a corresponding information publishing subsystem.

In addition, in an implementation, the apparatus may further include:

a second user identification determining unit that determines identification information of a plurality of different second users in the information publishing subsystem; and

a second user list providing unit that provides second user list information corresponding to each information publishing subsystem when providing the information publishing subsystem list to place the data object information per second user, and stores the corresponding relationship between the identification of the second user and the data object information.

Further, the apparatus includes:

a user information determining unit that determines the information attributes published by the second users respectively and/or audience user group feature information; and

a user information providing unit that provides the information attributes and/or audience user group feature information when the second user list information corresponding to each information publishing subsystem is provided, to place the data object information according to the information attributes and/or the audience user group feature information.

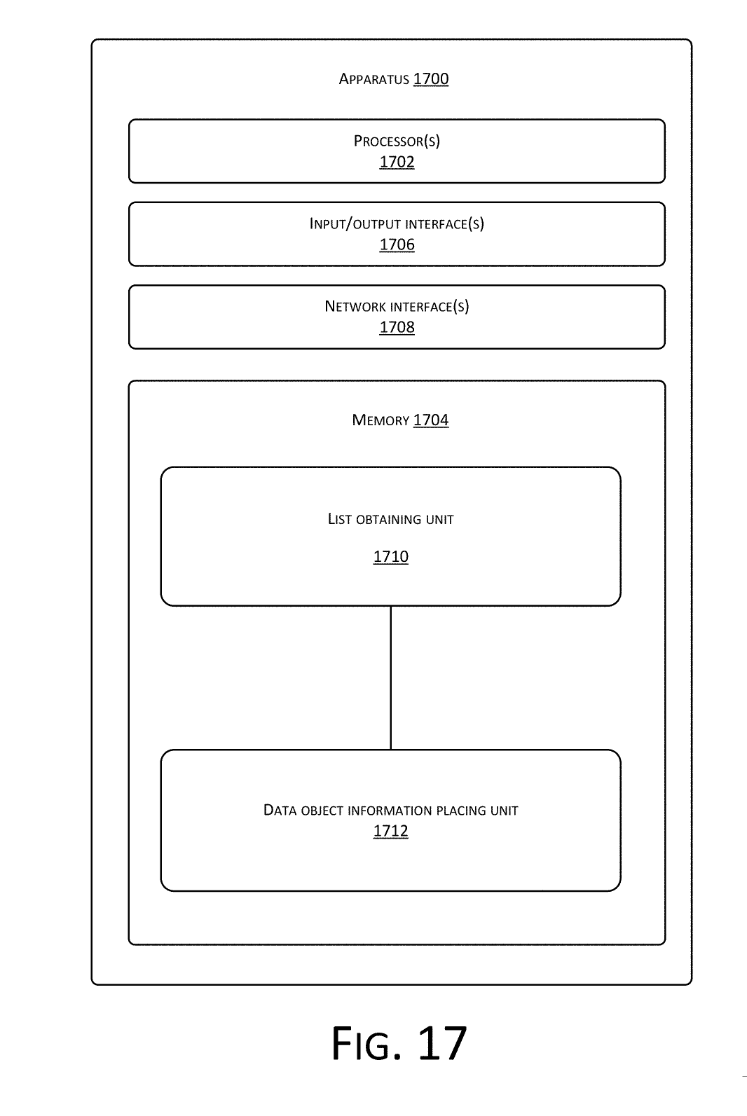

Corresponding to the eighth example embodiment, the present disclosure also provides an apparatus for processing data object information. Referring to FIG. 16, an apparatus 1600 is applied to a server of an information publishing subsystem.

The apparatus 1600 includes one or more processor(s) 1602 or data processing unit(s) and memory 1604. The apparatus 1600 may further include one or more input/output interface(s) 1606 and one or more network interface(s) 1608. The memory 1604 is an example of computer readable media.

The memory 1604 may store therein a plurality of modules or units including:

an access request sending unit 1610 that sends an access request to an access subsystem, so that the access subsystem adds the information publishing subsystem to a selectable information publishing subsystem list and, when receiving the data object placement request, provides the information publishing subsystem list and places the data object to the information publishing subsystem; and

an installation package receiving unit 1612 that receives the SDK package returned by the access subsystem after the access is successful, and provides the SDK package to the client terminal of the information publishing subsystem so that the client terminal of the information publishing subsystem establishes the information interaction channel with the access subsystem through the installation of the SDK package, obtains the data object list corresponding to the information publishing subsystem from the access subsystem, and generates the virtual item according to the data object information.

In an implementation, the apparatus may further include:

a system information providing unit that provides the access subsystem with the information attributes and/or audience user group feature information published in the information publishing subsystem, so that the access subsystem provides, in addition to the selectable information publishing sub-system list, the published information attributes and/or audience user group features information; and

a user information providing unit that provides the access subsystem with the second user list information in the information publishing subsystem, and information attributes respectively published by each second user respectively and/or audience user group information so that the access subsystem, when providing the selectable information publishing subsystem list, provides the second user list information, and information attributes published by each second user respectively and/or audience user group feature information.

Corresponding to the ninth example embodiment, the present disclosure also provides an apparatus for processing data object information. Referring to FIG. 17, an apparatus 1700 for providing data object information is applied to a data object placement subsystem.

The apparatus 1700 includes one or more processor(s) 1702 or data processing unit(s) and memory 1704. The apparatus 1700 may further include one or more input/output interface(s) 1706 and one or more network interface(s) 1708. The memory 1704 is an example of computer readable media.

The memory 1704 may store therein a plurality of modules or units including:

a list obtaining unit 1710 that obtains an information publishing subsystem list through an access subsystem;

a data object information placing unit 1712 that selects a target information publishing subsystem from the information publishing subsystem list to perform data object information placement, and the access subsystem stores the corresponding relationship between the information publishing subsystem and the data object information so that the first user client terminal in the information publishing subsystem generates the virtual item information according to the corresponding data object information.

As shown from the description of the foregoing example embodiments, those skilled in the art may clearly understand that the present disclosure may be implemented by means of software plus a necessary universal hardware platform. Based on this understanding, the technical solutions of the present disclosure essentially, or the part contributing to the conventional techniques, may be embodied in the form of a software product that is stored in a storage medium such as a ROM/RAM, a magnetic disk, an optical disk, etc., including instructions for enabling a computing device (which may be a personal computer, a server, or a network apparatus, etc.) to execute the method described in each example embodiment or part of the embodiment of the present disclosure.

Each example embodiment in the present disclosure is described in a progressive manner, the same or similar parts in various embodiments may refer to each other, and each example embodiment focuses on differences from other embodiments. For the system or system embodiment, since it is basically like the method embodiment, the description is relatively simple, and for the relevant part, reference may be made to the part description of the method embodiment. The system and system embodiments described above are merely exemplary. The units described as separate components may or may not be physically separate. The components displayed as units may or may not be physical units, which may be located in one place or distributed to multiple network elements. Some or all of the modules may be selected according to actual needs to achieve the objectives of the solutions in the example embodiments. Those skilled in the art may understand and implement these techniques without using any creative work.

The methods, apparatuses and systems for processing data object information provided in the present disclosure are described in detail above. Specific examples are used herein to describe the principles and implementation manners of the present disclosure. The description of the foregoing embodiments is merely intended to help understand the the present disclosure. Those skilled in the art may make changes to implementation manners and the application scope according to the idea of the present disclosure. In summary, the content of this specification should not be construed as a limitation of the present disclosure.

The present disclosure may further be understood with clauses as follows.

Clause 1. A data object information processing system comprising:

a data object information subsystem; and

an information publishing subsystem,

wherein:

the data object information subsystem provides selectable data object information to the information publishing subsystem;

the information publishing subsystem includes a server and a client terminal;

the server selects target data object information from the selectable data object information and provides virtual item information according to the target data object information when receiving a request for displaying a virtual item list sent from the client terminal, and returns the virtual item information to the client terminal; and

the client terminal displays, in the virtual item list, the virtual item information generated according to the data object information.

Clause 2. The system of clause 1, wherein the data object includes a product object published in a network transaction system.

Clause 3. The system of clause 2, wherein:

the virtual item information generated by the server includes an image of the virtual item generated according to a representative image of the product object; and

the client terminal displays the image of the virtual item in the virtual item list.

Clause 4. The system of clause 2 or 3, wherein:

the virtual item information generated by the server includes a link generated corresponding to a visit address of a target page of the product object; and

the client terminal, when a virtual item in the virtual item list is operated, displays the target page according to the link.

Clause 5. A data object information processing system comprising:

an access subsystem;

at least one information publishing subsystem, an information publishing subsystem includes a server and a client terminal; and

at least one data object placement subsystem,

wherein:

the server of the information publishing subsystem accesses the access subsystem;

the access subsystem provides a data object placement subsystem with an effective information publishing subsystem list according to the accessed information publishing subsystem;

the data object placement subsystem selects a target information publishing subsystem from the effective information publishing subsystem list to place data object information;

the access subsystem stores a corresponding relationship between the information publishing subsystem and the data object information;

the client terminal of the information publishing subsystem obtains a data object list corresponding to the information publishing subsystem from the access subsystem, generates a virtual item according to the data object information, sends information by using the virtual item, and, when the data object corresponding to the virtual item is operated, provides the corresponding data object information.

Clause 6. A data object information processing method comprising:

providing, by a first user client terminal of an information publishing subsystem, selectable virtual item information at a first user interface, the first user interface further including information published by a second user client terminal of the information publishing subsystem, a virtual item being generated according to data object information; and

after a target virtual item is selected, submitting a resource sending request to a server of the information publishing subsystem so that the server adds the target virtual item to a received virtual item list associated with the second user client terminal.

Clause 7. The method of clause 6, wherein the providing the selectable virtual item information at the first user interface includes:

submitting a request for obtaining the virtual item list to the server of the information publishing subsystem; and

providing virtual item information including a virtual item generated according to the data object information according to information returned by the server.

Clause 8. The method of clause 6, wherein:

the unified access system stores corresponding relationships between multiple information publishing subsystems and the data object information; and

the providing the selectable virtual item information at the first user interface includes:
submitting a request for obtaining the virtual item list to the access subsystem that is preset, the request including an identification of a corresponding information publishing subsystem, so that the access subsystem determines corresponding data object information according to the identification of the information publishing subsystem and returns the data object information;
generating a virtual item according to the data object information returned by the access subsystem; and
providing the virtual item at the first user interface.

Clause 9. The method of clause 6, wherein:

the virtual item is associated with virtual resource information; and

the server, when adding the target virtual item to a received virtual item list associated with the second user client terminal, transfer the virtual resource information to a virtual account associated with the second user client terminal according to the virtual resource information associated with the target virtual item.

Clause 10. The method of clause 6, wherein the virtual item is associated with front-end display information to be displayed in a candidate virtual item list.

Clause 11. The method of clause 10, wherein:

the data object includes a product object published in a preset network transaction system; and

the front-end display information of the corresponding target virtual item is generated according to a representative image of the product object.

Clause 12. The method of clause 11, further comprising:

displaying the received virtual item list associated with the second user client terminal at the first user interface; and

when the target virtual item in the received virtual item list is operated, providing information of a product object corresponding to the target virtual item in the preset network transaction system.

Clause 13. The method of clause 12, wherein:

the information of the product object in the preset network transaction system includes a link for details of the product object in the preset network transaction system; and

the method further comprises:

when the link for details is operated, providing a details page of the product object in the preset network transaction system according to a network address corresponding to the link for details.

Clause 14. The method of clause 13, wherein the details page of the product object in the preset network transaction system includes:

in response to determining that a terminal device of the first user client terminal installs a client terminal of the preset network transaction system, opening the client terminal of the preset network transaction system to display the details page.

Clause 15. The method of any of clauses 6-14, wherein:

different second users in the information publishing subsystem correspond to different data object information, a respective second user being an information publisher user in the information publishing subsystem;

the providing the selectable virtual item information at the first user interface includes determining data object information corresponding to the target second user after the first user client terminal is associated with the target second user; and

generating the virtual item according to the data object information corresponding to the target second user.

Clause 16. The method of clause 15, wherein:

the unified access subsystem stores the corresponding relationships between multiple information publishing subsystems and the data object information;

different second users in a same information publishing subsystem correspond to different data object information; and

the determining data object information corresponding to the target second user after the first user client terminal is associated with the target second user includes:
sending a request for obtaining the data object information to the access subsystem, the request carrying an information of the information publishing subsystem and information for identifying the second target user so that the access subsystem returns the data object information corresponding to the target second user; and
generating the virtual item according to the data object information corresponding to the second target user returned by the access subsystem.

Clause 17. The method of clause 16, wherein:

the information publishing subsystem includes a network live broadcast system;

the information published by the second user client terminal includes network live broadcast information published by the second user client terminal;

the second user client terminal submits a corresponding relationship between an identification of the second user and an identification of a virtual space to the access subsystem after the second user accesses the virtual space; and

the information for identifying the second target user includes an identification of the virtual space that is associated with the first user client terminal so that the access subsystem determines the identification of the target second user according to the identification of the virtual space and the corresponding relationship.

Clause 18. The method of clause 15, wherein:

the server of the information publishing subsystem stores different data object information corresponding to different second users; and

the determining data object information corresponding to the target second user after the first user client terminal is associated with the target second user includes:
sending a request for obtaining the data object information to the server so that the server returns the data object information corresponding to the target second user; and
generating the virtual item according to the data object information corresponding to the second user returned by the server.

Clause 19. A method for providing data object information comprising:

providing, by a second user client terminal of an information publishing subsystem, a second user interface including information published by the second user client terminal and a received virtual item list associated with the second user client terminal, the received virtual item list including a target virtual item generated according to a preset data object; and

when receiving an operation request for the target virtual item, providing data object information corresponding to the target virtual item.

Clause 20. The method of clause 19, wherein:

the information publishing subsystem includes a network live broadcast system; and

the method further comprises:

after the second user client terminal creates the virtual space for the second user, submitting a corresponding relationship between an identification of the second user and an identification of the virtual space to the access subsystem so that the access subsystem records the corresponding relationship, determines the corresponding identification of the second user according to the identification of the virtual space carried in the request when a first user client terminal submits the request for obtaining the data object information, returns the data object information corresponding to the identification of the second user to the first user client terminal and the first user client terminal generates a virtual item according to the data object information and sends the virtual item to the target virtual space corresponding to the second user client terminal.

Clause 21. A method for providing data object information comprising:

providing, by a third user client terminal of an information publishing subsystem, a third user interface including information published by a second user client terminal and a received virtual item list that is associated with the second user client terminal, the received virtual item list including a target virtual item generated according to a preset data object; and

when receiving an operation request for the target virtual item, providing data object information corresponding to the target virtual item.

Clause 22. A method for providing data object information comprising:

selecting, by a server of an information publishing subsystem, a target data object from a data object list provided by a data object information subsystem;

generating virtual item information according to the target data object; and

when receiving a request for obtaining the virtual item information submitted by a first user client terminal, providing the virtual item information so that the first user client terminal provides the virtual item information at a user interface.

Clause 23. The method of clause 22, wherein:

the selecting the target data object from the data object list provided by the data object information subsystem includes providing target data object information corresponding to each second user for multiple second users at the server of the information publishing subsystem; and

the providing the virtual item information includes:
when receiving the request for obtaining the virtual item information submitted by the first user client terminal, determining a second user associated with the first user client terminal; and
providing the virtual item information corresponding to the second user.

Clause 24. A method for providing data object information comprising:

generating, by an access subsystem, a selectable information publishing subsystem list according to an access request of an information publishing subsystem;

when receiving a data object placement request, providing the information publishing subsystem list;

determining and storing data object information for placement by a target information publishing subsystem; and

when receiving a request for obtaining the data object information submitted by a first user client terminal of the information publishing subsystem, returning the data object information corresponding to the information publishing subsystem to a first user client terminal so that the first user client terminal generates a virtual item according to the data object information.

Clause 25. The method of clause 24, further comprising:

determining an information attribute and/or audience group feature information published in the information publishing subsystem; and

providing, in addition to the information publishing subsystem list, the information attribute and/or audience group feature information published in the information publishing subsystem to place the data object to the corresponding information publishing subsystem according to the information attribute and/or audience group feature information.

Clause 26. The method of clause 24, further comprising:

determining an information attribute and/or audience group feature information published in the information publishing subsystem

determining a data object feature matching the information publishing subsystem according to the information attribute and/or audience group feature information published in the information publishing subsystem; and

providing, in addition to the information publishing subsystem list, matching data object features corresponding to each information publishing subsystem to place the data object to the corresponding information publishing subsystem according to the data object features.

Clause 27. The method of clause 24, further comprising:

determining identification information of multiple different second users in the information publishing subsystem;

providing, in addition to the information publishing subsystem list, second user list information corresponding to each information publishing subsystem to place data object information per a respective second user; and

storing a corresponding relationship between the identification of the second user and the data object information.

Clause 28. The method of clause 27, further comprising:

determining the information attribute and/or the audience group feature information published by each second user; and

providing, in addition to the second user list information corresponding to each information publishing subsystem, the information attribute and/or the audience group feature information to place data object information according to the information attribute and/or the audience group feature information.

Clause 29. A method for providing data object information comprising:

sending, by a server of an information publishing subsystem, an access request to an access subsystem so that the access subsystem adds the information publishing subsystem to a selectable information publishing subsystem list and, when receiving a data object placement request, provides the information publishing subsystem list, and perform a data object placement to the information publishing subsystem; and

after an access is successful, receiving a software development kit (SDK) returned by the access subsystem, and providing the SDK to a client terminal of the information publishing subsystem to establish an information interaction channel with the access subsystem, obtain a data object list corresponding to the information publishing subsystem from the access subsystem, and generates a virtual item according to the data object information.

Clause 30. The method of clause 29, further comprising:

providing information attribute and/or audience group feature information published in the access subsystem so that the access subsystem provides, in addition to the selectable information publishing subsystem list, second user list information and the published information attribute and/or audience group feature information.

Clause 31. The method of clause 29, further comprising:

providing the access subsystem with second user list information in the information publishing system, and the information attribute and/or the audience group feature information published by each second user so that the access subsystem provides, in addition to the selectable information publishing subsystem list, the second user list information and the information attribute and/or the audience group feature information published by each second user.

Clause 32. A method for providing data object information comprising:

obtaining, by a data object placement subsystem, an information publishing subsystem list through an access subsystem.

selecting a target information publishing subsystem from the information publishing subsystem list to perform data object information placement,

wherein:

the access subsystem stores a corresponding relationship between the information publishing subsystem and the data object information, so that a first user client terminal of the information publishing subsystem generates virtual item information according to the corresponding data object information.

Clause 33. An apparatus for processing data object information, applied to a first user client terminal of an information publishing subsystem, comprising:

a virtual item information providing unit that provides selectable virtual item information at a first user interface, wherein the first user interface further includes information published by a second user client terminal of the information publishing subsystem, and the virtual item is generated based on the data object information; and

a resource sending request submitting unit that submits a resource sending request to a server of the information publishing subsystem after a target virtual item is selected, wherein a server adds the target virtual item to a received virtual item list associated with the second user client terminal.

Clause 34. An apparatus for providing data object information, which is applied to a second user client terminal of an information publishing subsystem, comprising:

an interface providing unit that provides a second user interface, wherein the second user interface includes information published by the second user client terminal and a received virtual item list that is associated with the second user client terminal, and the received virtual item list includes a target virtual item generated according to a preset data object; and

a data object information providing unit that provides data object information corresponding to the target virtual item when receiving an operation request for the target virtual item.

Clause 35. An apparatus for providing data object information, which is applied to a third user client terminal of an information publishing subsystem, comprising:

an interface providing unit that provides a third user interface, wherein the third user interface includes information published by a second user client terminal and a received virtual item list that is associated with the second user client terminal, and the received virtual item list includes the target virtual item generated according to the preset data object; and

a data object information providing unit that provides information of a data object corresponding to the target virtual item when receiving an operation request for the target virtual item.

Clause 36. An apparatus for providing data object information, which is applied to a server of an information publishing subsystem, comprising:

a data object selection unit that selects a target data object from a data object list provided by a data object information subsystem;

a virtual item generating unit that generates virtual item information according to the target data object;

a virtual item providing unit that provides the virtual item information when receiving a request for obtaining the virtual item information submitted by a first user client terminal so that the first user client terminal provides the virtual item information at a user interface.

Clause 37. An apparatus for providing data object information, applied to an access subsystem, comprising:

a list generating unit that generates a selectable information publishing subsystem list according to an access request of an information publishing sub-system;

a list providing unit that provides the information publishing subsystem list when receiving a data object placing request; and

a data object information storing unit that determines and store data object information for placement by the target information publishing subsystem and returns the data object information corresponding to the information publishing subsystem to a first user client terminal when receiving the request for obtaining the data object information submitted by the first user client terminal of the information publishing subsystem so that the first user client terminal generates a virtual item according to the data object information.

Clause 38. An apparatus for providing data object information, which is applied to a server of an information publishing subsystem, comprising:

an access request sending unit that sends an access request to an access subsystem, so that the access subsystem adds the information publishing subsystem to a selectable information publishing subsystem list and, when receiving a data object placement request, provides the information publishing subsystem list and performs the data object placement to the information publishing subsystem; and

an installation package receiving unit that receives a software development kit (SDK) returned by the access subsystem after an access is successful and provides the SDK to a client terminal of the information publishing subsystem so that the client terminal of the information publishing subsystem establishes an information exchange channel with the access subsystem by installing the SDK, obtains a data object list corresponding to the information publishing subsystem from the access subsystem, and generates a virtual item according to the data object information.

Clause 39. An apparatus for providing data object information, applied to a data object placement subsystem, comprising:

a list obtaining unit that obtains an information publishing subsystem list through an access subsystem; and

a data object information placement unit that selects a target information publishing subsystem from the information publishing subsystem list to perform data object information placement, and the access subsystem stores the corresponding relationship between the information publishing subsystem and the data object information so that the first user client terminal of the information publishing subsystem generates the virtual item information according to the corresponding data object information.

What is claimed is:

1. A system comprising:
an information publishing subsystem including a server that:
selects data object information from selectable data object information;
provides virtual item information according to the data object information when receiving a request for displaying a virtual item list sent from a client terminal; and
returns the virtual item information to the client terminal.

2. The system of claim 1, further comprising a data object information subsystem that provides the selectable data object information to the information publishing subsystem.

3. The system of claim 1, wherein the data object information includes a product object published in a network transaction system.

4. The system of claim 3, wherein the virtual item information includes an image of a virtual item generated according to a representative image of the product object.

5. The system of claim 4, wherein the virtual item information includes a link generated corresponding to a visit address of a target page of the product object.

6. A method comprising:
providing, by a first user client terminal, selectable virtual item information at a first user interface, the first user interface further including information published by a second user client terminal; and
in response to determining that a virtual item is selected, submitting a resource sending request to a server to request the server to add the virtual item to a virtual item list associated with the second user client terminal.

7. The method of claim 6, wherein the providing the selectable virtual item information at the first user interface includes:
submitting a request for obtaining the virtual item list to the server; and
providing virtual item information according to information returned by the server, the virtual item information including the virtual item generated according to data object information.

8. The method of claim 6, further comprising:
storing a corresponding relationships between multiple information publishing subsystems and data object information.

9. The method of claim 8, wherein the providing the selectable virtual item information at the first user interface includes:
submitting a request for obtaining the virtual item list, the request including an identification of the information publishing subsystem;
receiving data object information according to the identification of the information publishing subsystem;
generating the virtual item according to the data object information; and
providing the virtual item at the first user interface.

10. The method of claim 9, wherein:
the virtual item is associated with virtual resource information.

11. The method of claim 10, wherein the submitting the resource sending request to the server includes:
requesting the server to transfer virtual resource information to a virtual account associated with the second user client terminal according to the virtual resource information associated with the virtual item.

12. The method of claim 9, wherein the virtual item is associated with front-end display information to be displayed in the virtual item list.

13. The method of claim 12, wherein the front-end display information is generated according to a representative image of a product object.

14. The method of claim 9, wherein:
the data object information includes a product object published in a network transaction system.

15. The method of claim 14, further comprising:
displaying the virtual item list associated with the second user client terminal at the first user interface; and
when the virtual item in the received virtual item list is operated, providing information of a product object corresponding to the virtual item in the network transaction system.

16. The method of claim 6, wherein:
different second users in the information publishing subsystem correspond to different data object information, a respective second user being an information publisher user in the information publishing subsystem;
the providing the selectable virtual item information at the first user interface includes determining data object information corresponding to the respective second user after the first user client terminal is associated with the respective second user; and
generating the virtual item according to the data object information corresponding to the respective second user.

17. The method of claim 16, wherein the determining the data object information corresponding to the respective second user includes:
sending a request for obtaining the data object information, the request carrying an information of the information publishing subsystem and information for identifying the respective second user;
receiving the data object information; and
generating the virtual item according to the data object information.

18. The method of claim 17, wherein:
the information published by the second user client terminal includes network live broadcast information published by the second user client terminal; and
the information for identifying the second user includes an identification of a virtual space that is associated with the first user client terminal.

19. The method of claim 16, wherein the determining the data object information corresponding to the respective second user includes:
sending a request for obtaining the data object information to the server;
receiving the data object information returned by the server; and
generating the virtual item according to the data object information.

20. One or more memories storing thereon computer-readable instructions that, when executed by one or more processors, cause the one or more processors to perform acts comprising:
providing, by a second user client terminal of an information publishing subsystem, a second user interface including information published by the second user client terminal and a virtual item list associated with the second user client terminal, the virtual item list including a virtual item generated according to a data object, the information publishing subsystem including a network live broadcast system;
in response to receiving an operation request for the virtual item, providing data object information corresponding to the virtual item;
creating a virtual space for a second user;
establishing a corresponding relationship between an identification of the second user and an identification of the virtual space;
receiving a virtual item that is generated according to data object information corresponding to the identification of the second user based on the identification of the virtual space and the corresponding relationship; and
displaying the virtual item at the second user interface.
